(19) United States
(12) Patent Application Publication
(10) Pub. No.: US 2008/0312383 A1
(43) Pub. Date: Dec. 18, 2008

(54) Thermosetting Resin Composition, And Laminate and Circuit Substrate Using Same

(75) Inventors: Shigeru Tanaka, Osaka (JP); Kanji Shimo-Ohsako, Osaka (JP); Takashi Itoh, Shiga (JP); Mutsuaki Murakami, Osaka (JP)

Correspondence Address: HOGAN & HARTSON L.L.P., 1999 AVENUE OF THE STARS, SUITE 1400, LOS ANGELES, CA, 90067, US

(73) Assignee: Kaneka Corporation, Osaka (JP)

(21) Appl. No.: 12/033,748

(22) Filed: Feb. 19, 2008

Related U.S. Application Data
(62) Division of application No. 10/505,727, filed on Aug. 25, 2004, now abandoned.

(30) Foreign Application Priority Data
Mar. 8, 2002 (JP) 2002064203
Jul. 9, 2002 (JP) 2002200576
Jul. 11, 2002 (JP) 2002203333
Nov. 5, 2002 (JP) 2002321523

(51) Int. Cl. C08G 73/10

(52) U.S. Cl. 525/408; 525/415

(57) ABSTRACT

A thermosetting resin composition of the present invention includes (A) a polyimide resin, and as thermosetting components, at least one of (B) a multifunctional cynate ester and (C) an epoxy resin. The (A) polyimide resin is soluble polyimide obtained by reacting, with diamines, acid dianhydride including an ether bond. As (B) the multifunctional cynate esters, a compound having a specific structure, and/or an oligomer thereof is used. As (C) the epoxy resin, an epoxy resin having a dicyclopentadiene bone structure and/or an alkoxy-group-including silane denatured epoxy resin (suitable epoxy resin) is preferably used.

### TECHNICAL FIELD

The present invention relates to a thermosetting resin composition including, as necessary components, (A) a polyimide resin, and at least one of (B) a multifunctional cynate ester (or its oligomer) and (C) an epoxy resin, the thermosetting resin composition being excellent in various properties such as dielectric properties, heat resistance, and adhesion. The present invention also relates to a laminate and a circuit substrate using the thermosetting resin composition. The thermosetting resin composition is suitable for producing laminates that require such properties as low dielectric properties, heat resistance, and excellent adhesion. Examples of such a laminate are laminate materials of flexible printed wiring circuits (FPCs) and of build-up wiring substrates, and the like.

### BACKGROUND ART

Recently, high-frequency signals are transmitted in circuits of various electronic devices and electric devices, in order to improve information-processing capabilities of these devices. In these devises, the circuits are wiring substrates (circuit substrates), which are made by forming wires on various substrates. Examples of the wiring substrates are flexible printed wiring substrates (also called FPCs), multi-layered printed wiring boards, and build-up wiring substrates (build-up circuit substrates).

Because high-frequency signals are used in the wiring substrates, it is necessary to maintain electrical reliability of the wires, and to suppress decrease of signal propagation velocity of the circuits, and loss of the signals. As a result, it is required that an adhesive material (resin material) that forms the circuit substrates has such dielectric properties that its dielectric constant and dielectric dissipation factor are low in GHz frequency range.

Conventionally, as the adhesive material, an epoxy-type adhesive material and a thermoplastic polyimide-type adhesive material are used, which are excellent in processability and adhesion.

The epoxy-type adhesive material is excellent in processability and adhesion, but is insufficient in dielectric properties. Specifically, with the epoxy-type adhesive material, bonding of adhesion targets (adherends) can be performed by applying a low temperature heat and a low pressure. The epoxy-type adhesive material is excellent also in adhesion to adherends. However, in the GHz frequency range, a dielectric constant of a cured epoxy-type adhesive material is not lower than 4, and a dielectric dissipation factor thereof is not lower than 0.02. As a result, there is a problem that the decrease of signal propagation velocity, and the loss of the signals are significant in the GHz frequency range.

On the other hand, the thermoplastic polyimide-type adhesive material is excellent in dielectric properties and heat resistance, but is insufficient in processability. Specifically, the thermoplastic polyimide-type adhesive material is excellent in heat resistance because the thermoplastic polyimide-type adhesive material has low thermal expansion and high thermal decomposition temperature, and the like. The thermoplastic polyimide-type adhesive material is excellent also in dielectric properties: a dielectric constant thereof is not higher than 3.5, and a dielectric dissipation factor thereof is lower than 0.02. However, there is a problem that, in order to bond the adherends with each other, it is necessary to perform bonding at a high temperature and under a high pressure.

In light of these problems, recently proposed is such an adhesive material (herein after “blended adhesive material”) that is made by blending epoxy resin and thermoplastic polyimide resin, as represented by the art disclosed in (1) Japanese Publication for Unexamined Patent Application, Tokukaihei 5-32726 (Publication Date: Feb. 9, 1993), and (2) Japanese Publication for Unexamined Patent Application, Tokukai 2000-109645 (Publication Date: Apr. 18, 2000).

The publication (1) discloses a resin composition obtained by reacting, with epoxy resin, polyimide resin having a polysiloxane block. The publication (2) discloses a resin composition consisting of specific polyimide resin and epoxy resin. The blended adhesive material can together attain excellent processability of the epoxy resin and excellent dielectric properties of the polyimide resin. Therefore, the blended adhesive material is more excellent than conventional adhesive materials in a balance of properties such as adhesion, heat resistance, and processability.

However, in the blended adhesive material, the dielectric properties of the polyimide resin tend to be lowered by mixing the epoxy resin. Specifically, as described above, the blended adhesive material is excellent in the balance of properties, but is insufficient in dielectric properties such as dielectric constant and dielectric dissipation factor. In particular, electrical properties in the GHz frequency range are insufficient for some uses. For example, if the resin composition disclosed in the publication (1) is used as an adhesive material, a dielectric constant is as high as not lower than 3.4, even if measured at 50 Hz, which is a relatively low frequency. The resin composition having such a high dielectric constant is unusable in the GHz frequency range. Therefore, there is a need for a blended adhesive material having improved dielectric properties.

As a recent attempt to improve the dielectric properties, the art disclosed in, for example, (3) Japanese Publication for Unexamined Patent Application, Tokukai 2001-200157 (Publication Date: Jul. 24, 2001) is proposed.

The publication (3) discloses a resin composition in which a polyimide resin and an cynate ester are mixed. With this art, the blended adhesive material attains an excellent balance among properties thereof. Therefore, the blended adhesive material can be effectively used in build-up wiring substrates, for example.

However, the art of the publication (3) also has such a problem that the blended adhesive material does not sufficiently adhere to an adhesive material for conductive metal (e.g. copper) that forms wires. Specifically, for example, the adhesion of the adhesive material is deteriorated by a pressure cooker test (herein after “PCT test”).

The present invention was made in light of the problems above. An objective of the present invention is to provide a thermosetting resin composition suitable for manufacturing various wiring substrates owing to (1) inclusion of polyimide resin as a necessary component, (2) excellency in at least dielectric properties, processability, and heat resistance in GHz frequency range, and (3) excellent adhesion after the PCT test (herein after “PCT resistance”), and to provide a laminate and a circuit substrate using the thermosetting resin composition.

### DISCLOSURE OF INVENTION

As a result of extensive study in light of the problems above, inventors of the present invention found out the following, and accomplished the present invention: By appropriately selecting (1) kinds of polyimide resin, which is a primary component, (2) kinds of thermosetting component such as cynate ester and epoxy resin, and (3) blending/mixing proportion of the polyimide resin and the thermosetting component, it is possible to attain (i) at least excellent dielectric properties, processability, and heat resistance among various properties, and further, excellent adhesion, especially PCT resistance, (ii) lower dielectric constant and dielectric dissipation factor in the GHz bands after curing than the conventional resin compositions, and (iii) the adhesion and PCT resistance better than the conventional resin compositions.

To solve the problems above, a thermosetting resin composition of the present invention includes:

(A) a polyimide resin; and

at least one of (B) a multifunctional cynate ester and (C) an epoxy resin, which are thermosetting components,

(A) the polyimide resin being soluble polyimide obtained by reacting, with a diamine, at least one of acid dianhydride represented by the following general formula (1):

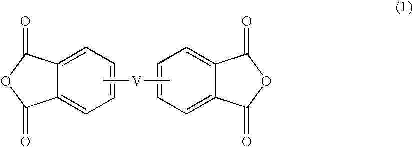

where V is a divalent group selected from the group consisting of —O—, —CO—, —O-T-O—, and COO-T-OCO—; and T is a divalent organic group. It is preferable that the diamine is at least one of diamines represented by the following general formula (4):

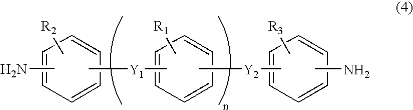

where of Y₁ and Y₂ are independently —C(═O) —, —SO₂—, —O—, —S—, (CH₂)ₘ—, —NHCO—, —C(CH₃)₂, —C(CF₃)₂—, —C(═O) O—, or a single bond (direct bond); R₁, R₂, and R₃ are independently hydrogen, a halogen group, or an alkyl group whose carbon number is not less than 1 and not more than 5; and m and n are integers not less than 1 and not more than 5. It is more preferable that the diamine is a diamine represented by the following general formula (5):

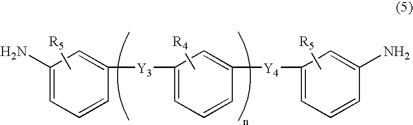

where Y₃ and Y₄ are independently —C(—O) —, —SO₂—, —O—, —S—, —(CH₂)ₘ—, —NHCO—, —C(CH₃)₂, —C(CF₃)₂—, —C(—O)O—, or a single bond (direct bond); R₄, R₅, and R₆ are hydrogen, a halogen group, or an alkyl group whose carbon number is not less than 1 and not more than 4; and m and n are integers not less than 1 and not more than 5. It is more preferable that the diamine is at least one of diamines including a hydroxyl group and/or a carboxyl group.

It is preferable that the acid dianhydride represented by general formula (1) is such that T in general formula (1) is an organic group represented by the following group (2):

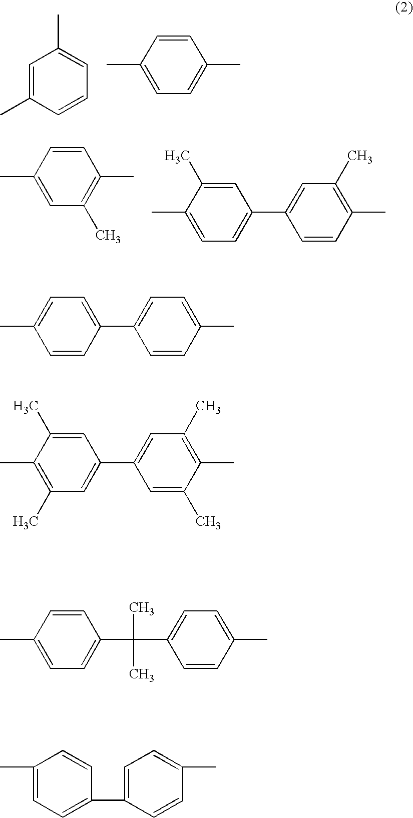

or an organic group represented by the following general formula (3):

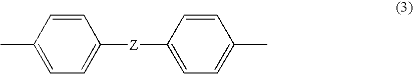

where Z is a divalent group selected from the group consisting of —C_{Q}H_{2Q}—, —C(═O) —, —SO₂—, —O—, and —S—; and Q is an integer not less than 1 and not more than 5.

Moreover, in the thermosetting resin composition of the present invention, it is preferable that a glass-transition temperature of the soluble polyimide used as (A) the polyimide resin is not higher than 250° C.

Furthermore, in the thermosetting resin composition of the present invention, it is preferable that (B) the multifunctional cynate ester is at least one of a multifunctional cynate ester and/or an oligomer thereof,

the multifunctional cynate ester being selected from compounds represented by the following general formula (6):

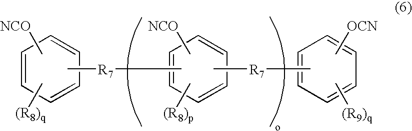

where R₇ is selected from —CH₂—, —C(CH₃)₂—, —C(CF₃)₂—, —CH(CH₃)—, —CH(CF₃), —SO₂—, —S—, —O—, and a bivalent organic group having at least one of a single bond, an aromatic ring, and an aliphatic ring; R₈ and R₉ are identically or differently selected from —H, —CH₃, and —CF₃; o is an integer not less than 0 and not more than 7; and p and q are identical or different integers not more than 0 and not less than 3. Moreover, it is preferable that (B) the multifunctional cynate ester is at least one of compounds represented by the following group (7):

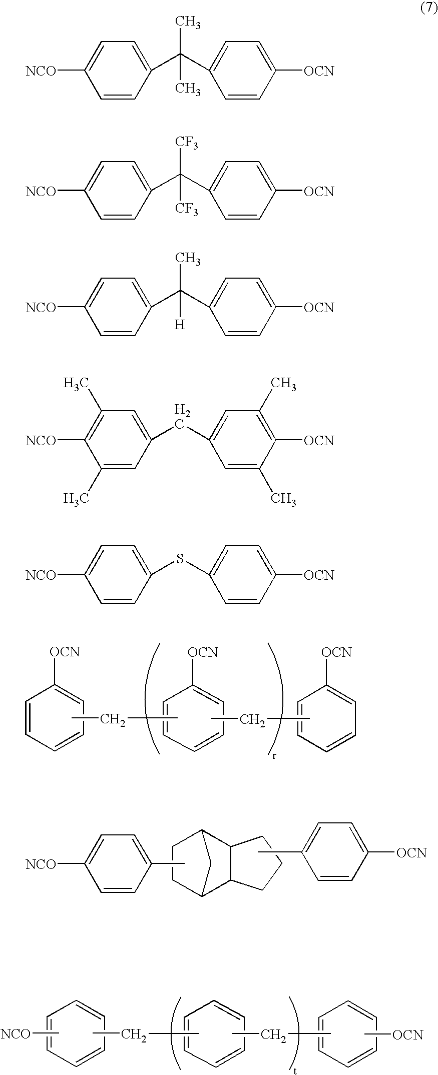

where r and t are integers not less than 0 and not more than 5.

Moreover, in the thermosetting resin composition of the present invention, it is preferable that (C) the epoxy resin is at least one of epoxy resins and/or an alkoxy-group-including silane denatured epoxy resin,

the epoxy resins represented by the following general formulas (8), (9) and (10):

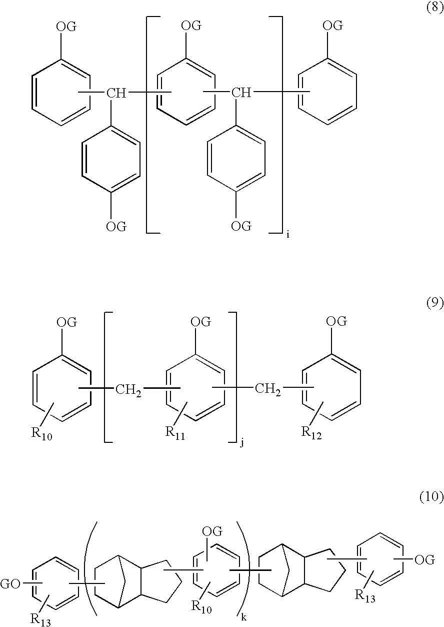

where G is an organic group represented by the following structural formula:

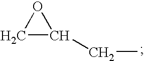

i, J, and k are integers respectively not less than 0 and not more than 5; and R₁₀, R₁₁, R₁₂, and R₁₃ are independently a hydrogen atom or an alkyl group whose carbon number is 1 to 4.

In the thermosetting resin composition of the present invention, it is preferable that, in accordance with desired properties, a mixing ratio of (A) the polyimide resin, (B) the multifunctional cynate ester, and (C) the epoxy resin, or a composition ratio thereof satisfies at least one of the following:

C_{A}:C_{B}=20:80 to 90:10;

C_{A}:C_{B}=95:5 to 85:15;

C_{A}:Cc=50:50 to 99:1;

C_{A}/(C_{A}+C_{B}+C_{C})=0.5 to 0.96;

C_{B}/(C_{A}+C_{B}+C_{C})=0.02 to 0.48; and

C_{C}/(C_{A}+C_{B}+C_{C})=0.002 to 0.48,

where C_{A} is a weight of all components of (A) the polyimide resin; C_{B} is a weight of all components of (B) the multifunctional cynate ester; and Cc is a weight of all components of (C) the epoxy resin.

The thermosetting resin composition of the present invention may include components other than (A) the polyimide resin, (B) the multifunctional cynate ester, and (C) the epoxy resin. For example, the thermosetting resin composition may include at least one of a curing catalyst and a curing agent, the curing catalyst accelerating curing of (B) the multifunctional cynate ester, and the curing agent accelerating curing of (C) the epoxy resin.

Here, it is preferable that the curing catalyst for accelerating curing of (B) the multifunctional cynate ester is at least one of zinc (II) acetylacetonato, zinc naphthenate, cobalt (II) acetylacetonato, cobalt (III) acetylacetonato, cobalt naphthenate, copper (II) acetylacetonato, and copper naphthenate. Moreover, the thermosetting resin composition may include a curing accelerator for accelerating a reaction between (C) the epoxy resin and the curing agent accelerating curing of (C) the epoxy resin.

It is preferable that the thermosetting resin composition of the present invention includes at least one of the following conditions (1) and (2): (1) a dielectric constant is not higher than 3.0, and a dielectric dissipation factor is not higher than 0.01, after curing with heat at 200° C. to 250° C. for 1 hour to 5 hours; and (2) adhesion to copper foil is not less than 5N/cm before and after PCT processing.

It is more preferable that the condition (1) is that the dielectric constant is not higher than 3.2, and the dielectric dissipation factor is not higher than 0.012.

Moreover, the thermosetting resin composition of the present invention may be a thermosetting resin composition including:

(A) a polyimide resin; and

at least one of (B) a multifunctional cynate ester and (C) an epoxy resin, which are thermosetting components,

(B) the multifunctional cynate ester being at least one of a multifunctional cynate ester and/or an oligomer thereof, the multifunctional cynate ester being selected from compounds represented by general formula (6),

(C) the epoxy resin being at least one of epoxy resins and/or an alkoxy-group-including silane denatured epoxy resin, the epoxy resins being represented by general formulas (8), (9) and (10).

A laminate of the present invention is a laminate including at least one layer including the thermosetting resin composition. A circuit substrate of the present invention is a circuit substrate including the thermosetting resin composition.

According to the arrangements above, the thermosetting resin composition of the present invention includes, as a primary component (A) the polyimide resin, and, as thermosetting components, at least one of (B) the multifunctional cynate ester and (C) the epoxy resin. Therefore, the thermosetting resin composition can attain the properties of the primary component and the properties of the thermosetting components sufficiently with an excellent balance.

Specifically, the thermosetting resin composition of the present invention has a low dielectric constant and a low dielectric dissipation factor in the GHz frequency range, and is excellent in processability, heat resistance, and adhesion, especially PCT resistance. As a result, the thermosetting resin composition of the present invention is suitable for manufacturing circuit substrates such as flexible wiring substrates (FPCs) and build-up wiring substrates, and for laminates etc. used in the circuit substrates.

For other objectives, features, and advantages of the present invention, reference should be made to the ensuing description. Benefits of the present invention are also made clear in the following description.

### BEST MODE FOR CARRYING OUT THE INVENTION

One embodiment of the present invention is specifically described below. Note that the present invention is not limited to this embodiment.

A thermosetting resin composition of the present invention includes, as a primary component (A) a polyimide resin, and, as a thermosetting component, at least one of (B) a multifunctional cynate ester (a monomer and/or an oligomer) and (C) an epoxy resin. The thermosetting resin composition is used to manufacture a laminate and a circuit substrate of the present invention.

### <(A) Polyimide Resin>

Although (A) the polyimide resin used in the present invention is not particularly limited, it is preferable that (A) the polyimide resin is soluble polyimide resin (herein after “soluble polyimide”). If soluble polyimide is used, it is not necessary to carry out a high temperature process for a long time for imidization after adding at least one of (B) the multifunctional cynate ester and (C) epoxy resin, which are thermosetting components. This is preferable because a thermosetting resin composition thus obtained has high processability.

The polyimide resin is “soluble” if, under a temperature ranging from room temperature to not more than 100° C., one percent by mass or more of the polyimide resin dissolves in at least one kind of solvent (herein after referred to as “solubility judging solvent” for the purpose of explanation) selected from dioxolane, dioxane, tetra hydrofuran, N, N-dimethylformamide, N, N-dimethylacetamide, and N-methyl-2-pyrrolidone. Here, the “room temperature” means temperatures ranging from 10° C. to 35° C.

The (A) polyimide resin used in the present invention can be produced by a well-known method. Specifically, (A) the polyimide resin can be produced by chemically or thermally imidizing polyamic acid, which is a precursor of the polyimide resin.

### <Acid Dianhydride>

In the present invention, there is no specific limitation as to acid dianhydride used as a material for the polyamic acid. However, in order to obtain soluble polyimide as a final product, it is preferable that at least one of acid dianhydride represented by the following general formula (1) is used:

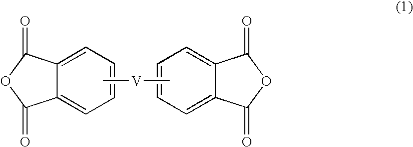

where V is a divalent group selected from the group consisting of —O—, —CO—, —O-T-O—, and COO-T-OCO—; and T is a divalent organic group. The acid dianhydride represented by general formula (1) may be an arbitrary one kind of compound, or a combination of more than one kind of compounds.

By using the acid dianhydride represented by general formula (1), it is possible to attain high solubility to the solubility judging solvent and high heat resistance, for example. Moreover, it is possible to obtain such soluble polyimide that is compatible with (B) a multifunctional cynate ester and (C) an epoxy resin, which are thermosetting components.

It is preferable that the acid dianhydride represented by general formula (1) is such that the divalent organic group denoted by T is an organic group represented by the following group (2):

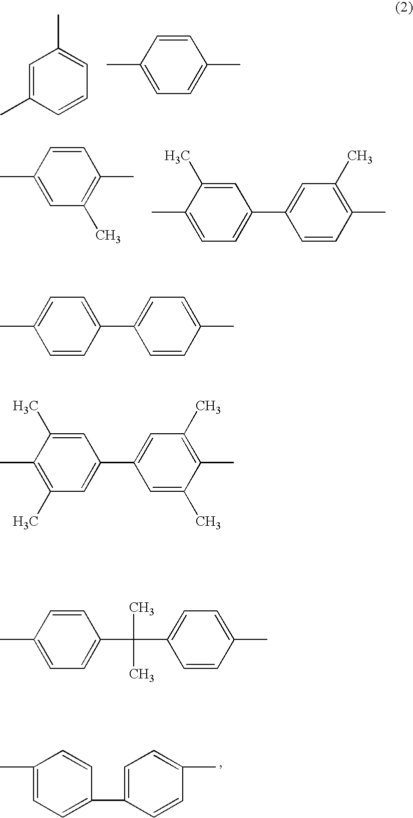

or an organic group represented by the following general formula (3):

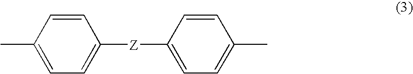

where Z is a divalent group selected from the group consisting of —C_{Q}H_{2Q}—, —C(═O) —, —SO₂—, —O—, and —S—; and Q is an integer not less than 1 and not more than 5.

By using at least one of the acid dianhydride that includes, as the organic group T, an organic group including an aromatic ring, the organic group being selected from the group (2) and general formula (3), it is possible to obtain such soluble polyimide that is particularly excellent in dielectric properties (specifically, a low dielectric constant and a low dielectric dissipation factor in GHz frequency range), and is excellent in heat resistance.

In light of an excellent balance among various properties such as solubility to the solubility judging solvent, compatibility with the thermosetting components, dielectric properties, and heat resistance, and in light of availability and other factors, it is most preferable to use, as the acid dianhydride represented by general formula (1), 4,4′-(4,4′-isopropylidendiphenoxy)bisphthalic acid dianhydride represented by the following structural formula:

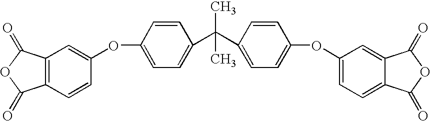

Alternatively, from the same point of view, it is also preferable to use, as the acid dianhydride represented by general formula (1), 2,2-bis(4-hydroxyphenyl) propanedibenzoate-3,3′,4,4′-tetracarboxylic acid dianhydride.

Needless to say, in the present invention, acid dianhydrides other than the acid dianhydride having the structure expressed in general formula (1) may be used. However, it is preferable that not less than 50 mol percent of all acid dianhydrides (the whole acid dianhydride components) used to produce the polyamic acid is the acid dianhydride represented by general formula (1). Such use of the acid dianhydride represented by general formula (1) is preferable in that it is possible to obtain such soluble polyimide that is excellent in solubility, compatibility with the thermosetting components, and dielectric properties.

The acid dianhydrides other than the acid dianhydride represented by general formula (1) are not particularly limited. Specific examples include: pyromellitic acid dianhydride; 3,3′,4,4′-benzophenonetetracarboxylic acid dianhydride; 3,3′,4,4′-diphenylsulfonetetracarboxylic acid dianhydride; 1,4,5,8-naphthalenetetracarboxylic acid dianhydride; 4,4′-oxydiphthalic acid anhydride 3,3′,4,4′-dimethyldiphenylsilanetetracarboxylic acid dianhydride; 1,2,3,4-furantetracarboxylic acid dianhydride; 4,4′-bis(3,4-dicarboxyphenoxy) diphenylpropane acid dianhydride; 4,4′-hexa fluoroisopropylidendiphthalic acid dianhydride; 3,3′,4,4′-biphenyltetracarboxylic acid dianhydride; 2,3,3′,4′-biphenyltetracarboxylic acid dianhydride; p-phenylenediphthalic acid anhydride; and the like. The acid dianhydride may be used solely, or more than one kind of the acid dianhydride may be used in appropriate combination at arbitrary ratios.

### <Diamine>

In the present invention, there is no specific limitation as to a diamine (diamine compound) used as a material of the polyamic acid. However, in order to obtain soluble polyimide as a final product, it is preferable that at least one of diamines (herein after referred to as “main diamines”, for the purpose of explanation) represented by the following general formula (4) is used:

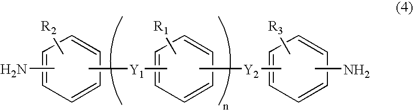

where Y₁ and Y₂ are independently —C(═O) —, —SO₂—, —O—, —S—, —(CH₂)ₘ—, —NHCO—, —C(CH₃)₂, —C(CF₃)₂—, —C(═O)O—, or a single bond (direct bond); R₁, R₂, and R₃ are and independently hydrogen, a halogen group, or an alkyl group whose carbon number is not less than 1 and not more than 5, preferably not less than 1 and not less than 4; and m and n are integers not less than 1 and not more than 5. As the diamines (main diamines) represented by general formula (4), arbitrary one kind of compound, or a combination of more than one kind of compounds may be used. The divalent group or the single bond denoted by Y₁ in general formula (4) may be the same or may be different in a recurring unit.

By using the main diamine, it is possible to obtain such soluble polyimide as a final product that is excellent in solubility, heat resistance and other properties, and that has low water-absorbing property.

The main diamine is not particularly limited. Specific examples of the main diamine include: bis[4-(3-amino phenoxy) phenyl]metane; bis[4-(4-aminophenoxy) phenyl]metane; 1,1-bis[4-(3-aminophenoxy) phenyl]ethane; 1,1-bis[4-(4-aminophenoxy) phenyl]ethane; 1, 2-bis[4-(3-aminophenoxy) phenyl]ethane; 1,2-bis[4-(4-aminophenoxy) phenyl]ethane; 2,2-bis[4-(3-aminophenoxy) phenyl]propane; 2,2-bis[4-(4-aminophenoxy) phenyl]propane; 2,2-bis[4-(3-aminophenoxy) phenyl]butane; 2,2-bis[3-(3-aminophenoxy) phenyl]-1,1,1,3,3,3-hexa fluoropropane; 2,2-bis[4-(4-aminophenoxy) phenyl]-1,1,1,3,3,3-hexa fluoropropane; 1,3-bis(3-aminophenoxy) benzene; 1,4-bis(3-aminophenoxy) benzene; 1,4′-bis(4-aminophenoxy) benzene; 4,4′-bis(4-aminophenoxy)biphenyl; bis[4-(3-aminophenoxy) phenyl]ketone; bis[4-(4-aminophenoxy) phenyl]ketone; bis[4-(3-aminophenoxy) phenyl]sulfide; bis[4-(4-aminophenoxy) phenyl]sulfide; bis[4-(3-aminophenoxy) phenyl]sulfone; bis[4-(4-aminophenoxy) phenyl]sulfone, bis[4-(3-aminophenoxy) phenyl]ether; bis[4-(4-aminophenoxy) phenyl]ether; 1,4-bis[4-(3-aminophenoxy) benzoyl]benzene; 1,3-bis[4-(3-aminophenoxy) benzoyl]benzene; 4,4′-bis[3-(4-aminophenoxy) benzoyl]diphenylether; 4,4′-bis[3-(3-aminophenoxy) benzoyl]diphenylether; 4,4′-bis[4-(4-amino-α,α-dimethylbenzyl) phenoxy]benzophenone; 4,4′-bis[4-(4-amino-α,α-dimethylbenzyl) phenoxy]diphenylsulfone; bis[4-{4-(4-aminophenoxy) phenoxy}phenyl]sulfone; 1,4-bis[4-(4-aminophenoxy)-α,α-dimethylbenzyl]benzene; 1,3-bis[4-(4-aminophenoxy)-α, λ-dimethylbenzyl]benzene; and the like.

As the main diamine, such a diamine (herein after referred to as “meta main diamine”, for the purpose of explanation) that has an amino group in a meta position is particularly preferred. That is, as the main diamine represented by general formula (4), it is preferable to use the meta main diamine represented by the following general formula (5):

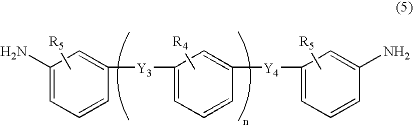

where Y₃ and Y₄ are independently —C(═O) —, —SO₂—, —O—, —S—, —(CH₂)ₘ—, —NHCO—, —C(CH₃)₂, —C(CF₃)₂—, —C(═O)O—, or a single bond (direct bond); R₄, R₅, and R₆ are independently hydrogen, a halogen group, or an alkyl group whose carbon number is not less than 1 and not more than 4; and m and n are integers not less than 1 and not more than 5. By using such a meta main diamine to produce the polyamic acid, it is possible to obtain, as a final product, such soluble polyimide that has more excellent solubility than that of a case in which main diamines having an amino group in a para position are used.

The meta main diamine is not particularly limited. Specific examples of the meta main diamine include: 1,1-bis[4-(3-aminophenoxy) phenyl]ethane; 1,2-bis[4-(3-amino phenoxy) phenyl]ethane; 2,2-bis[4-(3-aminophenoxy) phenyl]propane; 2,2-bis[4-(3-aminophenoxy) phenyl]butane; 2,2-bis[3-(3-aminophenoxy)phenyl]-1,1,1,3,3,3-hexa fluoropropane; 1,3-bis(3-aminophenoxy) benzene; 1,4-bis(3-aminophenoxy) benzene; bis[4-(3-aminophenoxy) phenyl]ketone; bis[4-(3-aminophenoxy)phenyl]sulfide; bis[4-(3-aminophenoxy) phenyl]sulfone; bis[4-(3-aminophenoxy) phenyl]ether; 1,4-bis[4-(3-aminophenoxy) benzoyl]benzene; 1,3-bis[4-(3-aminophenoxy) benzoyl]benzene; 4,4′-bis[3-(3-aminophenoxy) benzoyl]diphenylether; and the like.

As the main diamine or as the meta main diamine, it is particularly preferable to use, in particular, 1,3-bis(3-aminophenoxy) benzene. By using 1,3-bis(3-aminophenoxy) benzene to produce the polyamic acid, it is possible to obtain, as a final product, such soluble polyimide that is excellent in solubility to various organic solvents, solder heat resistance, and PCT resistance.

In the present invention, it is also preferable to use, in addition to the main diamine, such a diamine (herein after referred to as “non-main diamine”, for the purpose of explanation) that has at least one of a hydroxyl group and a carboxyl group. If the diamine used has the hydroxyl group and/or the carboxyl group, finally obtained soluble polyimide includes the hydroxyl group and/or the carboxyl group.

The soluble polyimide including a hydroxyl group and/or a carboxyl group can be used as a curing catalyst or a curing accelerator that cures (B) a multifunctional cynate ester and/or (C) an epoxy resin, which are thermosetting components. Therefore, a thermosetting resin composition including the soluble polyimide made of the non-main diamine can be cured at a low temperature or in a short period of time.

Moreover, because (B) the multifunctional cynate ester and/or (C) the epoxy resin, which are thermosetting components, can react with the hydroxyl group and/or the carboxyl group, the soluble polyimide made of the non-main diamine can be bridged by using an epoxy resin or the like. As a result, it is possible to obtain a thermosetting resin composition that is more excellent in heat resistance, solder heat resistance, and PCT resistance.

The non-main diamine is not particularly limited, as long as the non-main diamine is a diamine compound containing a hydroxyl group and/or a carboxyl group. However, specific examples of the non-main diamine include: (i) diaminophenols such as 2,4-diaminophenol, and the like; (ii) hydroxybiphenyl compounds such as 3,3′-diamino-4,4′-dihydroxybiphenyl, 4,4′-diamino-3,3′-dihydroxybiphenyl, 4,4′-diamino-2,2′-dihydroxybiphenyl 4,4-diamino-2,2′,5,5′-tetra hydroxybiphenyl, and the like; (iii) hydroxydiphenylalkanes such as hydroxydiphenylmetane such as 3,3′-diamino-4,4-dihydroxydiphenylmetane, 4,4′-diamino-3,3′-dihydroxydiphenylmetane, 4,4′-diamino-2,2′-dihydroxydiphenylmetane, 2,2-bis[3-amino-4-hydroxyphenyl]propane, 2,2-bis[4-amino-3-hydroxyphenyl]propane, 2,2-bis[3-amino-4-hydroxyphenyl]hexa fluoropropane, 4,4′-diamino-2,2′,5,5′-tetra hydroxydiphenylmetane, and the like; (iv) hydroxydiphenylether compound such as 3,3′-diamino-4,4′-dihydroxydiphenylether, 4,4′-diamino-3,3′-dihydroxydiphenylether, 4,4′-diamino-2,2′-dihydroxydiphenylether, 4,4′-diamino-2,2′,5,5′-tetra hydroxydiphenylether, and the like; (v) diphenylsulfone compound such as 3,3′-diamino-4,4′-dihydroxydiphenylsulfone, 4,4′-diamino-3,3′-dihydroxydiphenylsulfone, 4,4′-diamino-2,2′-dihydroxydiphenylsulfone, 4,4′-diamino-2,2′,5,5′-tetrahydroxydiphenylsulfone, and the like; (vi) bis[(hydroxyphenyl) phenyl]alkane compounds such as 2,2-bis[4-(4-amino-3-hydroxyphenoxy) phenyl]propane and the like; (vii) bis(hydroxyphenoxy) biphenyl compounds such as 4,4′-bis(4-amino-3-hydroxyphenoxy) biphenyl and the like; (viii) bis[(hydroxyphenoxy) phenyl]sulfone compound such as 2,2′-bis[4-(4-amino-3-hydroxyphenoxy) phenyl]sulfone and the like; (ix) diamino benzoic acids such as 3,5-diamino benzoic acid and the like; (x) carboxybiphenyl compounds such as 3,3′-diamino-4,4′-dicarboxybiphenyl, 4,4′-diamino-3,3′-dicarboxybiphenyl, 4,4′-diamino-2,2′-dicarboxybiphenyl, 4,4′-diamino-2,2′,5,5′-tetracarboxybiphenyl, and the like; (xi) carboxydiphenylalkanes such as carboxydiphenylmetane such as 3,3′-diamino-4,4′-dicarboxydiphenylmetane, 4,4′-diamino-3,3′-dihydroxydiphenylmetane, 4,4′-diamino-2,2′-dihydroxydiphenylmetane, 2,2-bis[4-amino-3-carboxyphenyl]propane, 2,2-bis[3-amino-4-carboxyphenyl]hexa fluoropropane, 4,4′-diamino-2,2′, 5,5′-tetracarboxydiphenylmetane, and the like; (xii) carboxydiphenylether compound such as 3,3′-di amino-4,4′-dicarboxydiphenylether, 4,4′-diamino-3,3′-dicarboxydiphenylether, 4,4′-diamino-2,2′-dicarboxydiphenylether, 4,4′-diamino-2,2′,5,5′-tetracarboxydiphenylether, and the like; (xiii) diphenylsulfone compound such as 3,3′-diamino-4,4′-dicarboxydiphenylsulfone, 4,4′-diamino-3,3′-dicarboxydiphenylsulfone, 4,4′-diamino-2,2′-dicarboxydiphenylsulfone, 4,4′-diamino-2,2′,5,5′-tetracarboxydiphenylsulfone, and the like; (xv) bis[(carboxyphenyl) phenyl]alkane compounds such as 2,2′-bis[4-(4-amino-3-carboxyphenoxy) phenyl]propane and the like; (xvi) bis(hydroxyphenoxy) biphenyl compounds such as 4,4′-bis(4-amino-3-hydroxyphenoxy) biphenyl and the like; (xvii) bis[(carboxyphenoxy) phenyl]sulfone compound such as 2,2-bis[4-(4-amino-3-carboxyphenoxy) phenyl]sulfone and the like; (xviii) and the like.

In the present invention, it is preferable that the main diamine and the non-main diamine are used in combination. In particular, it is particularly preferable to use, as the non-main diamine, 3,3′-dihydroxy-4,4′-diaminobiphenyl(4,4′-diamino-3,3′-dihydroxybiphenyl) represented by the following structural formula:

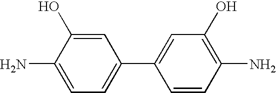

It is preferable to use 3,3′-dihydroxy-4,4′-diaminobiphenyl to produce the polyamic acid (and soluble polyimide, finally), because this makes it possible to obtain such a thermosetting resin composition that is excellent in solder heat resistance and PCT resistance.

In a case in which the main diamine and the non-main diamine are used in combination, it is more preferable that, among all the diamines (all the diamine components) used for producing the polyamic acid, the main diamines constitute 60 mol % to 99 mol %, and the non-main diamines (in particular, 3,3′-dihydroxy-4,4′-diaminobiphenyl) constitute 40 mol % to 1 mol %. If ratios of the two kinds of diamines to all the diamine components are not within the foregoing ranges, the soluble polyimide and thermosetting compound obtained tend to be deteriorated in terms of such properties as solubility, solder heat resistance, PCT resistance, and the like.

Moreover, in the present invention, a diamine other than the diamines described above (herein after referred to as “other diamine”, for the purpose of explanation) may be used in producing the polyamic acid (soluble polyimide).

The “other diamine” is not particularly limited. Specific examples of the “other diamine” include: m-phenylenediamine; o-phenylenediamine; p-phenylenediamine; m-aminobenzylamine; p-aminobenzylamine; bis(3-aminophenyl)sulfide; (3-aminophenyl) (4-aminophenyl)sulfide; bis(4-aminophenyl) sulfide; bis(3-aminophenyl) sulfoxide; (3-aminophenyl) (4-aminophenyl) sulfoxide; bis(3-aminophenyl) sulfone; (3-aminophenyl) (4-aminophenyl) sulfone; bis(4-aminophenyl) sulfone; 3,4′-diaminobenzophenone; 4,4′-diaminobenzophenone; 3,3′-diaminodiphenylmetane; 3,4′-diaminodiphenylmetane; 4,4′-diaminodiphenylmetane; 4,4′-diaminodiphenylether; 3,3′-diaminodiphenylether; 3,4′-diaminodiphenylether; bis[4-(3-aminophenoxy) phenyl]sulfoxide; bis[4-(aminophenoxy) phenyl]sulfoxide; and the like.

Although there is no particular limitation as to quantity of the “other diamine” used, it is preferable that the “other diamine” constitutes less than 10 mol % of all the diamine components, so that the soluble polyimide as a final product and the thermosetting resin composition including the soluble polyimide are not deteriorated in terms of various properties.

### <Obtaining Polyamide Acid by Polymerization>

In the present invention, it is more preferable that (A) the polyimide resin, which is the primary component, is the soluble polyimide produced by using the above-described material. The soluble polyimide is obtained by performing ring-closing dehydration (imidization) of the precursor (i.e. polyimide acid) whose structure is equivalent to that of the soluble polyimide. The polyimide acid, which is the precursor, can be obtained by polymerizing (synthesizing) the acid dianhydride and the diamine substantially equimolarly.

There is no specific limitation as to a polymerization reaction for producing the polyamic acid. A typical procedure for the polymerization reaction is as follows: (1) First, one or more kinds of diamines are dissolved or dispersed (diffused) in an organic polar solvent, so as to obtain a diamine solution; and (2) Then, one or more kinds of acid dianhydrides are added to the diamine solution, so that the monomers are polymerized. Thus, a polyamic acid solution is obtained.

There is no particular limitation as to an order of adding the monomers. The diamines may be added after the acid dianhydrides are added to the organic polar solvent. Alternatively, the order may be as follows: (1) An appropriate amount of diamines is added to the organic polar solvent; (2) Next, excess acid dianhydrides are added; and (3) The diamines that correspond to an excess amount are added. To add the monomers, there are various other ways well-known to those with ordinary skill in the art. Note that the term “dissolve” covers not only a case in which a solute is completely dissolved in a solvent, but also a case in which the solute is in a virtually dissolved state by being evenly diffused or dispersed in the solvent.

There is no particular limitation as to the organic polar solvent used for the polymerization reaction for producing the polyamic acid. Specific examples of the organic polar solvent include: (i) sulfoxide-type solvent such as dimethylsulfoxide, diethylsulfoxide, and the like; (ii) formamide-type solvent such as N, N-dimethylformamide, N, N-diethylformamide, and the like; (iii) acetamide-type solvent such as N, N-dimethylacetamide, N, N-dimethylacetamide, and the like; (iv) pyrrolidone-type solvent such as N-methyl-2-pyrrolidone and the like; (v) phenol-type solvent such as phenol, o-, m- or p-cresol, xylenol, phenol halide, catechol, and the like; (vi) hexamethylphosphoramide; (vii) γ-butyrolactone; (viii) and the like. Moreover, in addition to the organic polar solvent, aromatic carbon hydride such as xylene, toluene, or the like may be used in combination, according to needs.

### <Imidization of Polyamide Acid>

In the present invention, the soluble polyimide preferably used as (A) the polyimide resin is obtained by performing, using a thermal or chemical method, ring-closing dehydration (imidization) of the polyamic acid solution obtained as described above.

There is no particular limitation as to a specific method of the imidization. In a thermal method, the polyamic acid solution may be dehydrated by heat processing. In a chemical method, the polyamic acid solution may be dehydrated using a dehydrating agent. Moreover, the imidization may be performed by applying heat under reduced pressure. Regardless of which of the above methods is used for the imidization, it is preferable that the soluble polyimide used in the present invention is made by imidizing not less than 95% of the polyamic acid solution as compared with the polyamic acid, which is a precursor. If the soluble polyimide is made by imidizing not less than 95% of the polyamic acid solution, it is possible to attain various excellent properties, such as dielectric properties (low dielectric properties), PCT resistance, and heat resistance. The following describes methods for the imidization.

First, one example of the thermal method is a method in which an imidization reaction is caused by heat processing of the polyamic acid solution, while evaporating the solvent is evaporated. With this method, it is possible to obtain the soluble polyimide in a solid form. Although conditions for carrying out this method is not particularly limited, in the present embodiment, it is preferable that the heat processing is performed at a temperature not higher than 300° C. and within a time period of approximately 5 to 200 minutes.

Next, one example of the chemical method is a method in which, while the organic solvent is evaporated, ring-closing dehydration is performed by adding, to the polyamic acid solution, a dehydration agent and a catalyst in an amount not less than a stoichiometrically required amount. Also with this method, it is possible to obtain the soluble polyimide in a solid form. Although conditions for carrying out this method is not particularly limited, in the present embodiment, it is preferable that the dehydrating agent, the catalyst, a condition for heating in performing the ring-closing dehydration, and a condition for heating in evaporating the organic solvent are as follows, for example.

Examples of the dehydrating agent include: (i) aliphatic acid anhydride such as acetic anhydride and the like, (ii) aromatic acid anhydride such as benzoic acid anhydride and the like, (iii) and the like. Examples of the catalyst include: (i) aliphatic tertiary amines such as triethylamine and the like; (ii) aromatic tertiary amines such as dimethylaniline and the like; (iii) heterocyclic tertiary amines such as pyridine, α-picoline, β-picoline, γ-picoline, isoquinoline, and the like, (iv) and the like. It is preferable that the condition for heating in performing the ring-closing dehydration is a temperature not higher than 100° C., and that the condition for heating in evaporating the organic solvent is a temperature not higher than 200° C. and a time period within approximately 5 to 120 minutes.

Even if the thermal method or the chemical method is employed to obtain (A) the polyimide resin of the present invention, there is a method of obtaining the polyimide resin without evaporating the solvent. For the purpose of explanation, this method is referred to below as precipitation method, because the polyimide resin is precipitated in a poor solvent.

One example of the precipitation method is as follows: (1) First, imidization is performed by the thermal method or the chemical method, so as to obtain a polyimide resin solution; (2) Next, the polyimide resin solution is added to a poor solvent, so that the polyimide resin is precipitated, the poor solvent being such that the polyimide resin solution is not dissolved easily; and (3) Then, the polyimide resin precipitated is dried, so as to obtain the polyimide resin in a solid state.

The precipitation method is advantages in that an imidization method may be selected appropriately chosen from the thermal method and the chemical method, and that, because the polyimide resin is obtained by precipitation, the polyimide resin can be refined by removing non-reacted materials (monomers). Conditions for carrying out the precipitation method is not particularly limited. The poor solvent to be used here is such a poor solvent in which the solvent of the polyimide resin solution is dissolved easily, but the polyimide resin is not dissolved easily. Examples of the poor solvent include: acetone; methanol; ethanol; isopropanol; benzene; methylcellosolve; and methylethylketone. Needless to say, the poor solvent is not limited to these examples.

Next, an example of the imidization method in which heat is applied under reduced pressure (herein after referred to as “reduced pressure method”, for the purpose of explanation) is a method in which, while the solvent is evaporated, the polyamic acid solution is imidized by heat processing under reduced pressure. The reduced pressure method is advantageous in that it is possible to obtain high-molecular-mass polyimide resin, because water produced by the imidization can be readily removed from a system, thereby suppressing hydrolytic cleavage of the polyamic acid. Moreover, the reduced pressure method can further improve molecular mass of the polyimide resin, because it is possible to reclose a compound having an opened ring on one end or both ends, the compound existing as impurity in the acid dianhydride, which is a raw material of the polyimide resin.

Although conditions for carrying out the reduced pressure method are not particularly limited, in the present embodiment, it is preferable that a condition for heating and a condition for reducing pressure are as follows, for example.

First, it is preferable that the heat applied is within a range of 80° C. to 400° C. A lower limit for a temperature of the heat applied is preferably not lower than 100° C., and more preferably not lower than 120° C., in order to perform the imidization efficiently, and remove the water efficiently. Moreover, it is preferable that a maximum temperature for the heat applied (upper limit of the temperature of the heat applied), is not higher than a thermal decomposition temperature of the polyimide resin to be obtained. That is, the maximum temperature falls within a range of approximately 250° C. to 350° C., within which ordinary imidization is completed.

Next, it is preferable that the reduced pressure is as low as possible. More specifically, it is sufficient that the reduced pressure falls within a range of 0.9 to 0.001 atm. (910 hPa to 1 hPa). Preferably, the reduced pressure falls within a range of 0.7 to 0.01 atm. (810 hPa to 1 hPa), and more preferably within a range of 0.7 to 0.01 atm. (710 hPa to 1 hPa).

### <Properties of (A) Polyimide Resin Obtained>

There is no particular limitation as to properties of (A) the polyimide resin (especially soluble polyimide resin) obtained by the above-described manufacturing methods, as long as (A) the polyimide resin has properties sufficiently suitable for intended uses of the present invention.

One example of a main use of the present invention is a blended adhesive material for circuits used in various electronic devices and electric devices. In the present invention, the blended adhesive material (the thermosetting resin composition of the present invention) obtained by mixing (A) the polyimide acid, which is the primary component, with at least one of (B) the multifunctional cynate ester and (C) the epoxy resin is such that the blended adhesive material can attain various properties required. Needless to say, this is also true with other uses.

The properties required for the main use of the present invention, that is, the blended adhesive material for circuits used in various electronic devices and electric devices, are dielectric properties, processability, heat resistance, and PCT resistance, for example. The (A) polyimide resin, which is the primary component, can give the dielectric properties, heat resistance and the like to the blended adhesive material. Moreover, a glass transition temperature of the polyimide resin influences the processability of the blended adhesive material.

The glass transition temperature of the polyimide resin obtained by the above-described manufacturing method is relatively low. In order to give high processability to the thermosetting resin composition of the present invention, it is preferable that the glass transition temperature of (A) the polyimide resin is not higher than 350° C., more preferably not higher than 320° C., and yet more preferably not higher than 280° C.

In the present invention, if a method is adopted in which the blending/mixing proportion of (A) the polyimide resin and (B) the multifunctional cynate ester are adjusted to a predetermined range in blending (B) the multifunctional cynate ester with (A) the polyimide resin, it is preferable that the glass transition temperature of (A) the polyimide resin is not higher than 250° C., more preferably not high than 200° C., and yet more preferably not higher than 180° C.

If the glass transition temperature of (A) the polyimide resin is not higher than the upper limits above, it is possible to obtain a thermosetting resin composition (blended adhesive material) that has such properties as low coefficient of thermal expansion, high thermal decomposition temperature, and excellent dielectric properties. Moreover, because the glass transition temperature is low, it is possible to perform bonding of adherends by applying a relatively low temperature heat and a relatively low pressure. As a result, it is possible to improve the processability of the thermosetting resin composition (blended adhesive material) obtained.

### <(B) Multifunctional Cynate Esters>

Although (B) the multifunctional cynate ester used in the present invention are not particularly limited, it is preferable to use, especially in light of excellent heat resistance, at least one of the multifunctional cynate esters represented by the following general formula (6):

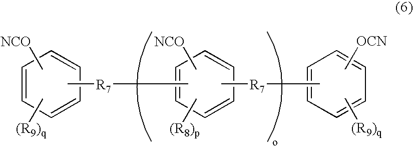

where R₇ is selected from —CH₂—, —C(CH₃)₂—, —C(CF₃)₂—, —CH(CH₃)—, —CH(CF₃), —SO₂—, —S—, —O—, and a bivalent organic group having at least one of a single bond, an aromatic ring, and an aliphatic ring; R₈ and R₉ are identically or differently selected from —H, —CH₃, and —CF₃; o is an integer not less than 0 and not more than 7; and p and q are identical or different integers not more than 0 and not less than 3.

Among the multifunctional cynate esters represented by general formula (6), for such reasons as high compatibility with the polyimide resin (readily compatible with the polyimide resin) and availability, it is preferable that at least one of compounds represented by the following group (7) is used:

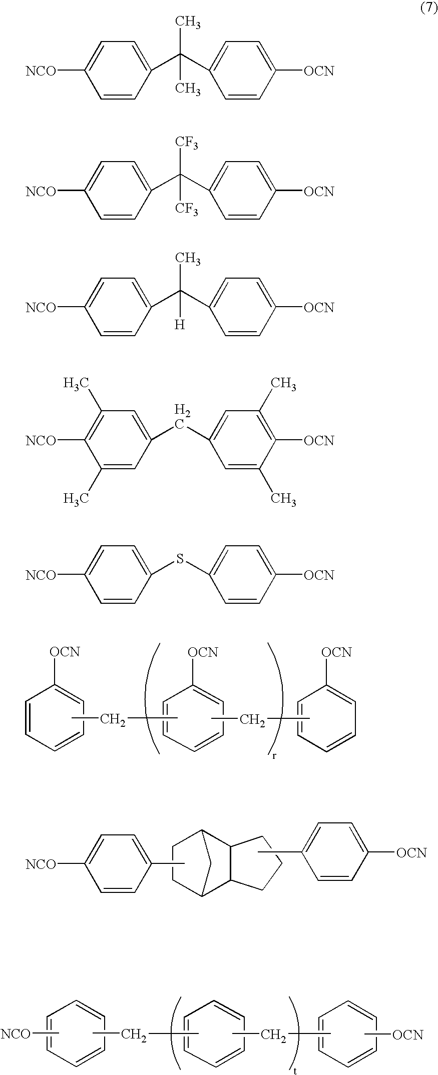

where r and t are integers not less than 0 and not more than 5, and it is particularly preferable to use 2,2-bis(4-cyanatephenyl) propane represented by the following structural formula:

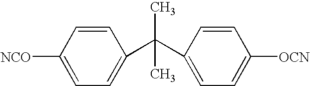

As (B) the multifunctional cynate ester, the compounds represented by general formula (6) may be used as a monomer. Moreover, (B) the multifunctional cynate ester may be an oligomer obtained by transforming, by heating for example, a part of a cyanate group of the compounds (monomers) represented by general formula (6) into a triazine ring (trimer of the cyanate group). Furthermore, the monomer and the oligomer may be used together as (B) the multifunctional cynate ester.

Specific examples of the oligomer of the multifunctional cynate ester include: an oligomer (e.g. product names Arocy B-30 and B-50 produced by Asahi-Chiba Limited) obtained by transforming, by reacting, 5% to 50% of all cyanate groups of 2,2-bis(4-cyanatephenyl) metane into triazine rings; and an oligomer (e.g. product names Arocy M-30 and M-50 produced by Asahi-Chiba Limited) obtained by transforming, by reacting, 5% to 50% of all cyanate groups of bis(3,5-dimethyl-4-cyanatephenyl) methane into triazine rings. However, the oligomer of the multifunctional cynate ester is not particularly limited

### <Mixing Ratio of (A) and (B)>

As long as the thermosetting resin composition of the present invention includes, as a thermosetting component, (B) a multifunctional cynate ester (a monomer and/or its oligomer), mixing ratios (mixing rates) of (A) the polyimide resin and (B) the multifunctional cynate ester are not particularly limited regardless of whether or not any other component is included, provided that the mixing ratios are within such ranges that do not deteriorate the dielectric properties. In accordance with desired properties, however, the following ranges are preferable.

Specifically, the mixing ratios of (A) the polyimide resin and (B) the multifunctional cynate ester may be adjusted in accordance with uses and processing methods of the thermosetting resin composition. The dielectric properties can be improved by increasing the mixing ratio of (A) the polyimide resin. On the other hand, adhesion and processability can be improved by increasing the mixing ratio of (B) the multifunctional cynate ester.

Therefore, in order to attain an excellent balance between the adhesion (adhesion to a conductive material such as copper foil and the like) and properties such as heat resistance (elasticity modulus, linear expansion coefficient, and the like of the thermosetting resin composition at a high temperature), it is preferable that a weight ratio (mass ratio) of (B) the multifunctional cynate ester to (A) the polyimide resin is within the following ranges:

C_{A}:C_{B}=20:80 to 90:10 (preferable range)

=30:70 to 80:20 (more preferable range)

=50:50 to 75:25 (yet more preferable range)

If the mixing ratio is not within these ranges, there is a possibility that the thermosetting resin composition obtained is deteriorated in terms of important properties for an adhesive material for various wiring substrates. The important properties are the dielectric properties, adhesion to a conductive material, heat resistance, and processability in bonding conductive materials or circuit substrates. Specifically, if the mixing ratio of (A) the polyimide resin is excessively high, the thermosetting resin composition of the present invention has low fluidity when heated. This results in inferior processability in performing thermal bonding. On the other hand, if the mixing ratio of (B) the multifunctional cynate ester is excessively high, the adhesion and dielectric properties are deteriorated.

Incidentally, the inventors of the present invention were the first to find that PCT tolerance (adhesion to a conductive material such as copper foil and the like before PCT processing and after the PCT processing) is improved as the mixing ratio of (A) the polyimide resin is increased.

Therefore, especially if the thermosetting resin composition obtained is used for such purposes for which improvement of the PCT tolerance is important, it is preferable that the weight ratio (mass ratio) of (B) the multifunctional cynate ester to (A) the polyimide resin is within the following range:

C_{A}:C_{B}=95:5 to 85:15

where C_{A} is a weight of all components of (A) the polyimide resin; and C_{B} is a weight of all components of (B) the multifunctional cynate ester.

If the mixing ratio is within this range, it is possible to attain an excellent balance between the PCT property and processability (processability in performing bonding). Moreover, if the mixing ratio is within this range, it is possible to attain adhesion sufficient for practical use.

On the other hand, if the mixing ratio is not within the range above, there is a possibility that the thermosetting resin composition obtained is deteriorated in terms of important properties for an adhesive material for various wiring substrates. The important properties are the dielectric properties, the adhesion to a conductive material, the heat resistance, and the processability in bonding conductive materials or circuit substrates. Specifically, if the mixing ratio of (A) the polyimide resin is excessively high (more than 95% by weight), the thermosetting resin composition of the present invention has low fluidity when heated. This often results in inferior processability in performing thermal bonding.

Moreover, because (B) the multifunctional cynate ester is a thermosetting component, it is preferable that an amount of (B) the multifunctional ester cyanid is not less than 5% by weight, so that the thermosetting resin composition obtained attains an excellent thermosetting property. On the other hand, if the mixing ratio of (B) the multifunctional cynate ester is excessively high (more than 15% by weight) in the thermosetting resin composition of the present invention, the adhesion, especially the adhesion after the PCT processing, of the thermosetting resin composition obtained is deteriorated (i.e. the PCT property is deteriorated).

### <Curing Catalyst of (B) Multifunctional Cynate Ester>

In the thermosetting resin composition of the present invention, if (B) the multifunctional cynate ester (a monomer and/or its oligomers) is used as a thermosetting component, a curing catalyst (or curing accelerator; herein after referred to as “cynate ester curing catalyst”, for the purpose of clear distinction from an epoxy curing catalyst and an epoxy curing accelerator, which are described later) may be used for accelerating curing of (B) the multifunctional cynate ester.

The thermosetting resin composition of the present invention needs to be so arranged that (B) the multifunctional cynate ester is cured to such an extent as to attain excellent dielectric properties after curing. Because of this, a curing reaction of (B) the multifunctional cynate ester often requires a high temperature of not lower than 200° C., and not less than 1 hour, preferably not less than 2 hours. Therefore, in order to accelerate the curing reaction of (B) the multifunctional cynate ester, it is preferable to use the cynate ester curing catalyst.

The cynate ester curing catalyst is not particularly limited, as long as the cynate ester curing catalyst is a compound that can accelerate the reaction of (B) the multifunctional cynate ester. Specific examples of the cynate ester curing catalyst include: (i) a metal catalyst such as zinc (II) acetylacetonato, zinc naphthenate, cobalt (II) acetylacetonato, cobalt (III) acetylacetonato, cobalt naphthenate, copper (II) acetylacetonato, copper naphthenate, and the like; (ii) an organic compound having a hydroxyl group, such as N-(4-hydroxyphenyl) maleimide, p-t-octylphenol, cumylphenol, phenol resin, and the like; (iii) and the like. As the cynate ester curing catalyst, these materials may be used alone, or may be used in combinations, as appropriate.

Among these materials used as the cynate ester curing catalyst, it is preferable to use the metal catalyst, because the metal catalyst can accelerate the curing to a greater extent. In particular, it is more preferable to use zinc (II) acetylacetonato, zinc naphthenate, cobalt (II) acetylacetonato, cobalt (III) acetylacetonato, cobalt naphthenate, copper (II) acetylacetonato, or copper naphthenate. Among these, it is yet more preferable to use the zinc (II) acetylacetonato or the copper (II) acetylacetonato.

There is no particular limitation as to a blending amount (use amount; mixing amount) of the cynate ester curing catalyst; the blending amount varies in accordance with a kind of the cynate ester curing catalyst, and in accordance with an extent to which the curing reaction is to be accelerated. For example, if the cynate ester curing catalyst is the metal catalyst, it is preferable to use, for 100 parts by weight of (B) the multifunctional cynate ester, the cynate ester curing catalyst within a range of 0.001 to 2 parts by weight (or parts by mass), more preferably within a range of 0.001 to 0.1 parts by weight. If the cynate ester curing catalyst is the organic compound, it is preferable to use the cynate ester curing catalyst within a range of 0.1 to 20 parts by weight for 100 parts by weight of (B) the multifunctional cynate ester.

In particular, if the cynate ester curing catalyst used is zinc (II) acetylacetonato or copper (II) acetylacetonato, it is preferable to use, with respect to 100 parts by weight of (B) the multifunctional cynate ester, the cynate ester curing catalyst within a range of 0.001 to 0.5 parts by weight (or mass parts), preferably within a range of 0.001 to 0.05 parts by weight. If the use amount of the cynate ester curing catalyst is less than the ranges above, it is difficult to attain an effect of accelerating the curing reaction. If the use amount is more than the ranges above, there is a possibility that the thermosetting resin composition cannot be stored stably. Therefore, it is undesirable to use the cynate ester curing catalyst in such an amount that is not within the ranges above.

### <(C) Epoxy Resin>

Different varieties of the (C) epoxy resin may be used in the present invention, depending on whether or not (B) the multifunctional cynate ester is used together as a thermosetting component.

If (B) the multifunctional cynate ester and (C) the epoxy resin are used together as thermosetting components, there is no particular limitation as to what kind of (C) the epoxy resin is used. Therefore, an arbitrary kind of epoxy resin may be used. Specific examples of the epoxy resin include: a bisphenol-type epoxy resin; a halogenated bisphenol-type epoxy resin; a phenolnovolak-type epoxy resin; an alkylphenolnovolak-type epoxy resin; a polyglycol-type epoxy resin; alicyclic epoxy resin; a cresolnovolak-type epoxy resin; a glycidylamine-type epoxy resin; an urethane denatured epoxy resin, a rubber denatured epoxy resin; an epoxy denatured polysiloxane; a suitable epoxy resin described later (suitable epoxy resin expressed by general formulas (8), (9), and/or (10) described later), and the like. The epoxy resins may be used alone, or may be used in combination, according to needs.

Among these epoxy resins, the suitable epoxy resin is used more preferably especially in light of availability (easy obtain ability) and excellent properties of the thermosetting resin composition obtained, such as heat resistance, adhesion, compatibility, an insulative property, and dielectric properties (a low dielectric constant and a low dielectric dissipation factor).

If (B) the multifunctional cynate ester is not used together as a thermosetting component, that is, if at least one of (A) the polyimide resin and (C) the epoxy resin is used, but (B) the multifunctional cynate ester is not used, at least one of epoxy resins and/or an alkoxy-group-including silane denatured epoxy resin is used, the epoxy resins being selected from epoxy resins represented by the following general formulas (8), (9) and (10):

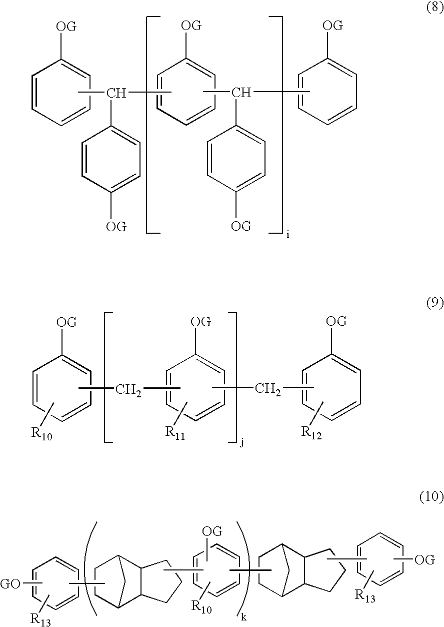

where G is an organic group represented by the following structural formula:

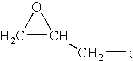

i, j, and k are integers respectively not less than 0 and not more than 5; and R₁₀, R₁₁, R₁₂, and R₁₃ are independently a hydrogen atom or an alkyl group whose carbon number is 1 to 4. Because the epoxy resins represented by general formulas (8), (9), and/or (10) are epoxy resins also suitable for a case in which (B) the multifunctional cynate ester is used together, in the present invention, the epoxy resins expressed by these general formulas are referred to as “suitable epoxy resins”, as described above.

Here, the alkoxy-group-including silane denatured epoxy resin is an epoxy resin obtained by partially or entirely reacting, with an alkoxysilane compound, hydroxyl groups included in an epoxy resin. A specific example of the alkoxy-group-including silane denatured epoxy resin includes an epoxy resin having a structure represented by the following general formula (11):

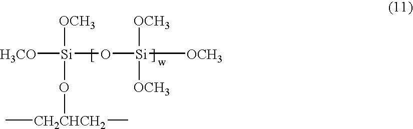

where w is an integer not less than 1.

As the suitable epoxy resin, preferably used is an epoxy resin in which an average of k in the formula is within a range of 0 to 2, so as to attain such properties as dielectric properties (a low dielectric constant and a low dielectric dissipation factor), heat resistance, and availability. Specific examples of such an epoxy resin include EXA7200 (average of k: 0.3) and EXA7200H (average of k: 1), which are products of Dainippon Ink And Chemicals, Incorporated. An example of an alkoxy-group-including silane denatured epoxy resin made from a bisphenol A-type epoxy resin is Compoceran E series produced by Arakawa Chemical Industries, Ltd.

In light of reliability of an electrical insulating property, it is preferable that (C) the epoxy resin used in the present invention has high purity. Specifically, it is preferable that a concentration of halogen and alkaline metal included in the epoxy resin is not higher than 25 ppm, more preferably not higher than 15 ppm, where the measurement of the concentration is performed by extraction at a temperature of 120° C. and under a pressure not higher than 2 atm. If the concentration is not higher than these upper limits, it can be judged in the present invention that the epoxy resin has high purity. Meanwhile, the epoxy resin is suitable. It is undesirable that the concentration of the halogen and alkaline metal included in the epoxy resin is higher than 25 ppm, because there is a possibility that such a high concentration of the halogen and alkaline metal deteriorates the reliability of the thermosetting resin composition of the present invention.

As described above, the epoxy resin used as (C) the epoxy resin of the present invention is not limited to the suitable epoxy resin, if (B) the multifunctional cynate ester is used together. In particular, in the present invention, an epoxy resin (herein after referred to as “adhesion/heat resistance improving epoxy resin”, for the purpose of explanation) other than the suitable epoxy resin may be used to improve the adhesion and heat resistance of the thermosetting resin composition obtained.

The adhesion/heat resistance improving epoxy resin is not particularly limited. Specific examples of the adhesion/heat resistance improving epoxy resin include: a bisphenol-type epoxy resin; a halogenated bisphenol-type epoxy resin; a phenolnovolak-type epoxy resin; an allylphenolnovolak resin; an alkylphenolnovolak-type epoxy resin; a biphenyl-type epoxy resin; a naphthalene-type epoxy resin; a polyglycol-type epoxy resin; alicyclic epoxy resin; a cresolnovolak-type epoxy resin; a glycidylamine-type epoxy resin; an urethane denatured epoxy resin, a rubber denatured epoxy resin; an epoxy denatured polysiloxane, and the like.

These materials used as the adhesion/heat resistance improving epoxy resin may be used alone, or may be used in combinations of more than one kind, as appropriate. There is no particular limitation as to a blending amount (use amount; mixing amount) of the adhesion/heat resistance improving epoxy resin, as long as the dielectric properties of the thermosetting resin composition obtained are not deteriorated. However, it is preferable that the adhesion/heat resistance improving epoxy resin is used within a range of approximately 1 to 5 parts by weight with respect to 100 parts by weight of a total resin component (including not only (C) the epoxy resin, but also (A) the polyimide resin, and a resins corresponding to (D) other component, which are described later). If the blending amount of the adhesion/heat resistance improving epoxy resin is less than 1 weight part, an effect of improving the adhesion and the like cannot be attained easily. On the other hand, if the blending amount of the adhesion/heat resistance improving epoxy resin is more than 5 parts by weight, the dielectric properties are deteriorated.

It is preferable that, like the suitable epoxy resin, the adhesion/heat resistance improving epoxy resin has high purity. Specifically, it is preferable that a concentration of halogen and alkaline metal included in the resin is within the above-described ranges.

Needless to say, (C) the epoxy resin used in the present invention is not limited to the suitable epoxy resin and the adhesion/heat resistance improving epoxy resin. The suitable epoxy resin and the adhesion/heat resistance improving epoxy resin may be used together with other epoxy resin, in accordance with intended uses. Alternatively, instead of the suitable epoxy resin, other epoxy resin may be used as the main (C) epoxy resin.

### <Mixing Ratio of (A) and (C), or Mixing Ratio of (A), (B), and (C)>

As long as the thermosetting resin composition of the present invention includes (C) the epoxy resin as a thermosetting component, a mixing ratio (mixing rate) of (A) the polyimide resin and (C) the epoxy resin is not particularly limited regardless of whether or not any other component is included, provided that the dielectric properties are not deteriorated. However, in accordance with desired properties, the following ranges are preferable.

At least (A) the polyimide resin and (C) the epoxy resin (the suitable epoxy resin, in this case) are used. If (B) the multifunctional cynate ester is not used, it is preferable that, by weight (mass ratio), the mixing ratio of (C) the epoxy resin to (A) the polyimide resin is within the following ranges:

$$\begin{matrix}{C}_{A} \text{:} Cc = 50 \text{:} 50 to 99 \text{:} 1 ( preferable range ) \\ = 60 \text{:} 40 to 95 \text{:} 5 ( more preferable range ) \\ = 75 \text{:} 25 to 90 \text{:} 10 ( yet more preferable range )\end{matrix}$$

where Cc is a weight of all components of (C) the epoxy resin.

If the mixing ratio is within these ranges, it is possible to attain an excellent balance between the adhesion (adhesion to a conductive material such as copper foil and the like) and properties such as heat resistance (an elasticity modulus, a linear expansion coefficient, and the like property of the thermosetting resin composition at a high temperature).

On the other hand, if the mixing ratio is not within these ranges, there is a possibility that the thermosetting resin composition obtained is deteriorated in terms of important properties for an adhesive material for various wiring substrates. The important properties are the dielectric properties, the adhesion to a conductive material, the heat resistance, and the processability in bonding conductive materials or circuit substrates. Specifically, if the mixing ratio of (A) the polyimide resin is excessively high, the thermosetting resin composition of the present invention has low fluidity when heated. This results in inferior processability in performing thermal bonding. On the other hand, if the mixing ratio of (C) the epoxy resin is excessively high, the dielectric properties are deteriorated.

Next, if (B) the multifunctional cynate ester and (C) the epoxy resin are used together, that is, if (A) the polyimide resin, (B) the multifunctional cynate ester (a monomers and/or its oligomer), and (C) the epoxy resin are used, it is preferable that, by weight (mass ratio), mixing ratios of (A) the polyimide resin, (B) the multifunctional cynate ester, and (C) the epoxy resin are within the following ranges, respectively:

C_{A}/(C_{A}+C_{B}+C_{C})=0.5 to 0.96

C_{B}/(C_{A}+C_{B}+C_{C})=0.02 to 0.48

Cc/(C_{A}+C_{B}+C_{C})=0.002 to 0.48

If the mixing ratios are within these ranges, it is possible to attain an excellent balance between the adhesion (adhesion to a conductive material such as copper foil and the like) and properties such as the heat resistance (the elasticity modulus, the linear expansion coefficient, and the like of the thermosetting resin composition at a high temperature).

On the other hand, if the mixing ratios are not within these ranges, there is a possibility that the thermosetting resin composition obtained is deteriorated in terms of important properties for an adhesive material for various wiring substrates. The important properties are the dielectric properties, the adhesion to a conductive material, the heat resistance, and the processability in bonding conductive materials or circuit substrates. Specifically, if the mixing ratio of (A) the polyimide resin is excessively high, the thermosetting resin composition of the present invention has low fluidity when heated. This results in inferior processability in performing thermal bonding. On the other hand, if the mixing ratio of (C) the epoxy resin is excessively high, the adhesion and the dielectric properties are deteriorated. Moreover, if the mixing ratio of (C) the epoxy resin is excessively high, the dielectric properties are deteriorated.

In order to obtain a thermosetting resin composition having a thermosetting property, it is preferable that a sum of (B) the multifunctional cynate ester and (C) the epoxy resin, which are thermosetting components, is at least 4% by weight.

### <Curing Agent for (C) Epoxy Resins>

If (C) the epoxy resin is used as a thermosetting component in the thermosetting resin composition of the present invention, a curing agent (herein after referred to as “epoxy curing agent”, for clear distinction from the cynate ester curing catalyst) for the epoxy resin may be used in order to accelerate curing of (C) the epoxy resin, as in the case of (B) the multifunctional cynate ester.

The epoxy curing agent is not particularly limited. Specific examples of the epoxy curing agent include: (i) an aromatic diamine-type compound such as bis(4-aminophenyl) sulfone, bis(4-aminophenyl) metane, 1,5-diaminonaphthalen, p-phenylenediamine, m-phenylenediamine, o-phenylenediamine, 2,6-dichloro-1,4-benzenediamine, 1,3-di(p-aminophenyl) propane, m-xylenediamine, and the like; (ii) an aliphatic amine-type compound such as ethylenediamine, diethylenediamine, tetraethylenepentamine, diethylaminopropylamine, hexamethylenediamine, menthendiamine, isophoronediamine, bis(4-amino-3-methyldicyclohexyl) metane, polymethylenediamine, polyetherdiamine, and the like; (iii) aliphatic acid anhydride such as a polyaminoamide-type compound, dodecyl succinic anhydride, polyadipic acid anhydrate, polyazelaic acid anhydrate, and the like; (iv) alicyclic acid anhydride such as hexahydrophthalic acid anhydrate, methylhexahydrophthalic acid and the like; (v) aromatic acid anhydride such as phthalic acid anhydride, trimellitic acid anhydride, benzophenonetetracarboxylic acid, ethylenglycolbistrimellitate, glyceroltristrimellitate, and the like; (vi) a novolak resin such as phenol, cresol, alkylphenol, catechol, bisphenol A, bisphenol F, and the like, and halogenated phenol resin thereof, and the like; (vii) phenol resins; amino resins; urea resins; melamine resins; dicyandiamide; dihydrazine compounds; imidazole compounds; Lewis acid and Brønsted acid salines; polymercaptan compounds; and isocyanate and block isocyanate compounds, (viii) and the like.

These materials used as the epoxy curing agent may be used alone, or may be used in combinations of more than one kind, according to needs. Although a blending amount (use amount; mixing amount) of the epoxy curing agent is not particularly limited, in general, it is preferable that the blending amount is within a range of 5 to 200 parts by weight with respect to 100 parts by weight of (C) the epoxy resin. It is particularly preferable that the epoxy curing agent is blended in an amount equivalent to an epoxy equivalent.

Furthermore, in the thermosetting resin composition of the present invention, a curing accelerator (herein after referred to as “epoxy curing accelerator”, for clear distinction from the cynate ester curing catalyst) may be used if necessary in combination with the epoxy curing agent, in order to accelerate a reaction between (C) the epoxy resin and the epoxy curing agent.

The epoxy curing accelerator is not particularly limited. Specific examples of the epoxy curing accelerator include: triphenylphosphine; tertiary amine type; trimethanolamine; triethanolamine; tetraethanolamine; 1,8-diaza-bicyclo[5,4,0]-7-undeceniumtetraphenylborate; imidazole; 2-ethylimidazole; 2-ethyl-4-methylimidazole; 2-phenylimidazole; 2-undecylimidazole; 1-benzil-2-methylimidazole; 2-heptadecylimidazole; 2-isopropylimidazole; 2,4-dimethylimidazole; 2-phenyl-4-methylimidazole; 2-methylimidazoline; 2-ethylimidazoline; 2-isopropylimidazoline; 2-phenylimidazoline; 2-undecylimidazoline; 2,4-dimethylimidazoline; 2-phenyl-4-methylimidazoline; and the like.

These materials used as the epoxy curing accelerator may be used alone, or may be used in combinations of more than one kind, according to needs. Although a blending amount (use amount; mixing amount) of the epoxy curing accelerator is not particularly limited, in general, it is preferable that the blending amount is within a range of 0.01 to 10 parts by weight for 100 parts by weight of (C) the epoxy resin.

### <(D) Other Component 1: Other Resin>

As long as the thermosetting resin composition of the present invention includes, as a primary component (A) the polyimide resin, and, as a thermosetting component at least one of (B) the multifunctional cynate ester and (C) the epoxy resin, other component is not particularly limited. Therefore, the thermosetting resin composition of the present invention may include a component (herein after referred to as “(D) other component”, for the purpose of explanation) other than (A), (B), and (C).

A specific example of (D) other components is (D-1) other thermosetting resin. The (D-1) other thermosetting resin is used as a thermosetting component, like (B) the multifunctional cynate ester (a monomer and/or its oligomer) and (C) the epoxy resin. If (D-1) other thermosetting resin is used together with (B) and/or (C), it is possible to improve various properties of the thermosetting resin composition obtained, such as adhesion, heat resistance, processability, and the like.

Specific examples of thermosetting resin used as (D-1) other thermosetting resin include: (i) thermosetting resin such as bismaleimide resin, bis-allyl-nadi-imide resin, phenol resin, acrylic resin, methacrylic resin, hydrosillyl cured resin, allyl cured resin, unsaturated polyester resin, and the like; (ii) side chain reactive group thermosetting polymer having, at a side chain or a tail end of a polymer chain, a reactive group such as an allyl group, a vinyl group, an alcoxisillyl group, a hydrosillyl group, or the like; (iii) and the like.

(D-1) other thermosetting resin may be used alone, or may be used in combinations of more than one kind, as appropriate. There is no particular limitation as to a blending amount (use amount; mixing amount) of (D-1) other thermosetting resin, as long as the dielectric properties of the thermosetting resin composition obtained are not deteriorated.

### <(D) Other Component 2: Organic Solvent>

A specific example of (D) other component is (D-2) an organic solvent. If (D-2) the organic solvent is used, it is possible to improve the fluidity of the thermosetting resin composition in bonding adherends with each other.

(D-2) the organic solvent is not particularly limited, as long as the thermosetting resin composition of the present invention, that is, (A) the polyimide resin, (B) the multifunctional cynate ester, (C) the epoxy resin, (D-1) other thermosetting resin, and the like, can be dissolved in the organic solvent. In particular, an organic solvent whose boiling temperature is not higher than 200° C. is preferable.

Specifically, the following ethers are preferably used, for example: (i) cyclic ether such as tetra hydrofuran, dioxorane, dioxane, and the like; (ii) chain ether such as ethyleneglycoldimethylether, triglyme, diethylenglycol, ethylcellosolve, methylcellosolve, and the like, (iii) and the like. Moreover, also used preferably are mixed solvents in which the ethers are mixed with toluene, xylenes, glycols, N, N-dimethylformamide, N, N-dimethylacetamide, N-methylpyrrolidone, cyclic siloxane, chain siloxane, or the like.

As described later, there are cases in which the thermosetting resin composition of the present invention is used in a pre-cured state (B-stage state). In such cases, when the thermosetting resin composition in the B-stage state is pressurized and heated, the thermosetting resin composition flows into a gap between adherends (e.g. between circuits), and the like space. At this time, an important factor is to what extent the thermosetting resin composition flows and fills the gap and the like space. The inventors of the present invention found, on their own, that the organic solvent included in the thermosetting resin composition has a significant influence on the fluidity.

Specifically, in order to control the fluidity of the thermosetting resin composition of the present invention pressurized and heated, it is preferable that the thermosetting resin composition includes the organic solvent. In other words, the organic solvent is included in the thermosetting resin composition of the present invention in order to control the fluidity of the thermosetting resin composition.

There is no particular limitation as to an amount of the organic solvent-blended with the thermosetting resin composition of the present invention to attain a desired fluidity; the amount is to be set as appropriate. In general, however, the amount is preferably 1% by weight to 20% by weight, and more preferably 3% by weight to 10% by weight. If the amount is within these ranges, sufficient fluidity can be attained.

### <Thermosetting Resin Composition>

Methods of manufacturing the thermosetting resin composition of the present invention are not particularly limited, as long as (A) the polyimide resin, (B) the multifunctional cynate ester, and/or (C) the epoxy resin, and, if necessary, (D) other component are mixed.

Moreover, states and shapes of the thermosetting resin composition of the present invention are not particularly limited, as long as at least (A) the polyimide resin, (B) the multifunctional cynate ester, and/or (C) the epoxy resin are included, and (D) other component is included depending on intended uses and the like. In short, the thermosetting resin composition of the present invention may be used in many specific ways with no particular limitation, as long as those with ordinary skill in the art can carry out the present invention.

There is no particular limitation as to specific states of the thermosetting resin composition of the present invention. The thermosetting resin composition may be in a solid form, in a state of a solution prepared from the thermosetting resin composition in the solid form, or in other states prepared from the thermosetting resin composition in the solid form.

In a case of a solution of the thermosetting resin composition of the present invention, that is, in a case in which the thermosetting resin composition of the present invention is dissolved in a solvent and used as a resin solution, the solvent used is not particularly limited, as long as the thermosetting resin composition of the present invention dissolves in the solvent. However, it is preferable that a boiling temperature of the solvent is not higher than 150° C. Specifically, preferably used solvents are the ethers and/or mixed solvents thereof, which are mentioned above as examples of (D-2) organic solvent.

There is no particular limitation as to methods of preparing (producing method of the solution from the thermosetting resin composition in the solid state. A specific example is a method in which the solution is produced by adding, to the solvent, each component ((A), (B), (C), and other component) of the thermosetting resin composition of the present invention, and stirring the solvent. An other specific example is a method in which the solution is produced by respectively dissolving the components in solvents, thereby preparing component solvents, and mixing the component solvents with each other.

Even if the thermosetting resin composition of the present invention is in the solid form, the thermosetting resin composition may include the solvent. For example, if the thermosetting resin composition is a resin sheet or a resin film as described later, various solvents may be included in advance, as described in the section of <(D) Other Component 2: Organic Solvent>, in order to control the fluidity of the thermosetting resin composition.

Thus, (D-2) organic solvent may be included in the thermosetting resin composition of the present invention as one component thereof, or may be included not as one component of the thermosetting resin composition (in other words, the (D-2) organic solvent may be a non-compositional addition).

Next, in a case in which the thermosetting resin composition of the present invention is in the solid form, specific shapes of the thermosetting resin composition are not particularly limited. For example, the thermosetting resin composition may be used as a A resin sheet shaped into a sheet in advance, or a resin film shaped into a film in advance.

The resin sheet and the resin film are the thermosetting resin composition processed into a sheet or a film, respectively. Specific forms of the resin sheet and the resin film are a single-layered sheet, a two-layered or three-layered sheet, and a multi-layered sheet. The single-layered sheet is a sheet consisting exclusively of the thermosetting resin composition. The two-layered or three-layered sheet is a sheet having a resin layer consisting of the thermosetting resin composition of the present invention formed on one surface or both surfaces of a film (substrate film) that is to be a substrate. The multi-layered sheet is a sheet on which the substrate film and the resin layer consisting of the thermosetting resin composition are laminated alternately.

An advantage of the resin sheet is as follows. For example, the thermosetting resin composition of the present invention is used in order to manufacture a laminate or a circuit substrate that are multi-layered like a build-up wiring substrate. In this case, the thermosetting resin composition of the present invention in the pre-cured state (B-stage state) is pressurized and/or heated, so that the thermosetting resin composition flows into a gap between circuits (made of a conductive material such as copper and the like). In case the thermosetting resin composition is the resin sheet or the resin film, the resin film or the resin film is laminated on the circuits.

If the thermosetting resin composition is the resin solution, the resin solution is applied on a surface of the circuits (substrate on which the circuits are formed) so as to form a laminate. On the other hand, if the thermosetting resin composition is the resin sheet or the resin film, what is required is only to laminate the resin sheet or the resin film on the adherend, and then pressurize and/or heat the resin sheet or the resin film. Therefore, no application step is necessary. This makes it possible, for example, to simplify process of manufacturing the laminate. However, there are cases in which the resin solution is more preferable, depending on a shape of the adherend.

Methods of manufacturing the resin sheet and/or the resin film are not particularly limited. In general, the single-layered sheet is manufactured as follows: (1) The resin solution obtained by the above-described manufacturing method is flow-casted or applied on a surface of a supporting body (resin solution application step); (2) The resin solution applied is dried (drying step); and (3) a sheet obtained after drying is pealed off from the supporting body (pealing-off step).

The two-layered or three-layered sheet is manufactured by flow-casting or applying the resin solution onto a surface (one surface or both surfaces) of a substrate film (resin solution application step), and drying the resin solution, so as to form a resin layer (drying step). The multi-layered sheet is manufactured by laminating undried two-layered or three-layered sheet prepared before the drying step in the manufacture of the two-layered or three-layered sheet.

In case the thermosetting resin composition of the present invention is used as the resin sheet or the resin film, the resin sheet or the resin film may be fiber-reinforced. Specific examples of fiber used for a fiber-reinforced resin sheet include: glass fabric; glass mat; aromatic polyamide fiber fabric; aromatic polyamide fiber mat, and the like. However, the fiber used for a fiber-reinforced resin sheet is not particularly limited. One example of manufacturing methods for the fiber-reinforced resin sheet is a method in which fiber is soaked into a varnish (resin solution), so as to half-cure the resin solution. However, the manufacturing methods are not particularly limited.

### <Post-Heating Processing>

If the thermosetting resin composition of the present invention includes (B) the multifunctional cynate ester as a thermosetting component, and the multifunctional cynate ester is a monomer-type, or if the thermosetting resin composition includes (C) the epoxy resin as a thermosetting component, it is preferable to carry out post-heating processing after the thermosetting resin composition is adhered to the adherend. By carrying out the post-heating processing, it is possible to further the curing reactions of the monomer-type multifunctional cynate ester or the epoxy resin sufficiently.

Specific conditions for the post-heating processing are not particularly limited. For example, suitable conditions are as follows: (1) A heating temperature is within a range of 150° C. to 250° C.; and (2) heating time is approximately within a range of 10 minutes to 3 hours, preferably within a range of 1 hour to 3 hours, approximately. On the other hand, if the thermosetting component is the epoxy resin, suitable conditions are as follows, for example: (1) A heating temperature is within a range of 150° C. to 200° C.; and (2) heating time is approximately within a range of 10 minutes to 3 hours.

### <Dielectric Properties of Thermosetting Resin Composition>

In the present invention, it is judged that the thermosetting resin composition has excellently low dielectric properties, if the dielectric constant and the dielectric dissipation factor measured after curing are within the following ranges. That is, when the thermosetting resin composition of the present invention is cured with heat at a temperature of 200° C. to 250° C. for 1 hour to 5 hours, it is sufficient that the dielectric constant at a frequency of 1 GHz to 10 GHz is not higher than 3.5, preferably not higher than 3.2, and more preferably not higher than 3.0, and the dielectric dissipation factor at the frequency of 1 GHz to 10 GHz is not higher than 0.010, preferably not higher than 0.015, and more preferably not higher than 0.012.

If the dielectric properties are within these ranges, it is possible, even if the thermosetting resin composition of the present invention is used to produce a circuit substrate having minute wires, to maintain electrical reliability of the minute wires, and to increase a signal propagation velocity of the circuit.

Needless to say, the thermosetting resin composition of the present invention may include a component other than the above-described components, as long as the properties of the thermosetting resin composition are not deteriorated. Likewise, needless to say, the thermosetting resin composition may be manufactured in such a method that includes a step other than the above-described steps.

### <Laminate and Circuit Substrate>

A laminate of the present invention is not particularly limited, as long as the laminate includes the thermosetting resin composition of the present invention. Specific examples of the laminate include (i) resin sheets such as the two-layered or three-layered sheet and the multi-layered sheet, (ii) a metal foil laminate, (iii) and the like.

The metal foil laminate has, on one surface or both surfaces of a metal layer of copper, aluminum, or the like, a resin layer (herein after simply referred to as “resin layer”, for the purpose of explanation) that includes the thermosetting resin composition of the present invention. More specifically, the metal foil laminate is a laminate that includes at least one resin layer and at least one metal foil layer. Specific examples of the metal foil laminate includes (i) a two-layered laminate having the resin layer on one surface of the metal foil layer, and (ii) a multi-layered laminate having at least one metal foil layer and at least one resin layer, the metal foil layer and the resin layer being laminated alternately, (iii) and the like.

Methods of manufacturing the metal foil laminate are not particularly limited. For example, the metal foil laminate may be manufactured by the method of manufacturing the two-layered or three-layered sheet or the method of manufacturing the multi-layered sheet, among the methods of manufacturing the resin sheet. Specifically, the metal foil laminate is manufactured by flow-casting or applying the resin solution onto a surface (one surface or both surfaces) of the metal foil (resin solution application step), and drying, in order to form the resin layer, the resin solution that has been flow-casted or applied (drying step).

The metal foil laminate may be manufactured also by bonding the resin sheet onto a surface of the metal foil. In this method, the resin sheet may be the single-layered sheet, the two-layered or three-layered sheet, or the multi-layered sheet. Furthermore, the metal foil laminate may be manufactured also by forming metal foil on the resin sheet by chemical plating or sputtering.

Specific arrangements of the metal foil are not particularly limited, as long as the metal foil is made of metal that can be used as a conductive material of the circuit substrate. In general, the foil is made of a material such as copper or aluminum, as described above. Moreover, thickness of the metal foil is not particularly limited; the thickness may be set appropriately according to kinds of circuits to be formed.

The circuit substrate of the present invention is manufactured by, for example, forming circuits of a desired pattern on the metal foil (conductive layer) of the metal foil laminate by means of metal etching or the like. Although the metal etching employed here is not limited to a specific method, a suitable method is a method using dry film resist, liquid resist, or the like. The patterns of the circuits are not particularly limited.

The present invention is more specifically described below based on specific examples. The examples are described only for explanatory purposes, not for limiting the present invention. It should be noted in particular that, although various comparative examples are described below in order to explain effects of the present invention more clearly, the comparative examples are not entirely out of the scope of the present invention. Some of the comparative examples are titled as such merely for the purpose of convenience, that is, in order to explain specific options in the present invention. Therefore, the scope of the present invention is not limited to the following examples and comparative examples. Various changes, modifications, and alternations can be made by one with ordinary skill in the art within the scope of the present invention.

Note that glass-transition temperatures of the polyimide resin obtained in the following synthesis examples, dielectric properties and thermal properties of cured thermosetting resin compositions obtained in the examples and comparative examples, and strength of the copper foil against peeling of a metal foil laminate plate having a resin layer including the thermosetting resin composition were measured and evaluated as follows.

### [Glass-Transition Temperature]

Using a dynamic viscoelasticity evaluating apparatus DMS200 (product name; made by Seiko Instruments, Inc.) as a measuring apparatus, measurement was performed under the following conditions. Note that tan δ peak temperatures obtained were used as the glass-transition temperatures.

| | |
|---|---|
| Range of temperatures: | 30° C. to 350° C. |
| Shape of specimen: | 9 mm × 40 mm |
| Frequency: | 5 Hz |

### [Dielectric Properties]

Using a cavity resonators for permittivity measurement in purturbation method (product name; made by Kanto Electronics Application and Development Inc.), permittivities and dielectric dissipation factors were measured under the following conditions.

| | |
|---|---|
| Frequency: | 3 GHz, 5 GHz, and 10 GHz |
| Temperature: | 22° C. to 24° C. |
| Humidity: | 45% to 55% |
| Specimen Conditioning: | The specimens shall be left for 24 hours |
| | under the conditions above |

### [Thermal Properties]

In order to evaluate the thermal properties, coefficients of thermal expansion were measured by TMA-50 (product name; made by Shimadzu Corporation) under the following conditions. An average of the coefficients of thermal expansion at a temperature in a range of 100° C. to 200° C. was used as a coefficient of thermal expansion of specimens.

| | |
|---|---|
| Measurement method: | Tensile mode (so adjusted that a load |
| | applied to the specimens is 0 g) |
| Heating rate: | 10° C./minute |
| Range of temperatures: | 30° C. to 300° C. |
| Atmosphere: | Nitrogen (flow rate: 50 ml/minute) |
| Specimens: | Cured resin heated at 300° C. for one |
| | minute to mitigate distortion caused |
| | when cured |
| Shape of specimens: | 5 mm (width) × 50 μm |
| | (thickness) |
| Distance of measurement | 15 mm |
| (distance between chucks): | |

### [Copper Foil Peeling Strength]

The metal foil of the metal foil laminates obtained was masked, and then etched to form a conductive layer of 3 mm width, and was used as measurement specimens. Then, strength of the copper foil against peeling (at peeling angle of 180°) was measured in accordance with JIS C6481. A pressure cooker test (PCT test) were conducted on the specimens. Conditions for the tests were 121° C., 100% RH, and 96 hours. After the PCT test, strength of the copper foil against peeling of the specimens were measured in the above-described manner.

### SYNTHESIS EXAMPLE OF SOLUBLE POLYIMIDE

### Synthesis Example 1

Into a 2000 ml glass flask, dimethylformamide (herein after “DMF”), 1,3-bis(3-aminophenoxy) benzene (product of Mitsui Chemicals, Inc.; herein after “APB”), and 3,3′-dihydroxy-4,4′-diaminobiphenyl (product of Wakayama Seika Kogyo, Ltd.; herein after “HAB”) were poured, and then stirred and dissolved under an atmosphere of nitrogen. The DMF was 0.95 equivalent, and the HAB was 0.05 equivalent.

While keeping inside of the flask under the atmosphere of nitrogen, the solution was further stirred with cooling by using iced water, and 4,4′-(4,4′-isopropylidenediphenoxy) bisphthalic acid anhydride (product of GE; herein after “IPBP”) of 1 equivalent was added thereto. Then, the solution was stirred for another 3 hours.

Thereby a polyamic acid solution was obtained. The amount of DMF used was so arranged that the monomer concentration of APB, HAB, and IPBP to be mixed in was 30% by weight. In other words, the amount of DMF used was so arranged that the product polyamic acid solution contained 30% by weight of polyamic acid.

300 g of the polyamic acid solution was then transferred to a butt coated with fluoro resin, and the solution was heated in a vacuum oven for 3 hours at 200° C., under a reduced pressure of 5 mmHg (about 0.007 atm., or about 5.65 hPa), thereby obtaining a polyimide resin (a), which was a soluble polyimide.

### Synthesis Example 2

Except that bis[4-(3-aminophenoxy) phenyl]sulfone (product of Wakayama Seika Kogyo, Ltd.; herein after “BAPS-M”) was used instead of APB, a polyimide resin (b), which was a soluble polyimide, was obtained in the same manner as Synthesis Example 1 in terms of quantity and conditions.

### Synthesis Example 3

Except that 2,2-bis(4-hydroxyphenyl) propanedibenzoate-3,3′,4,4′-tetracarboxylic acid dianhydride (product of Honshu Chemical Industry Co. Ltd.; herein after “ESDA”) was used instead of IPBP, a polyimide resin (c), which was a soluble polyimide, was obtained in the same manner as Synthesis Example 1 in terms of quantity and conditions.

### Preparation Example of Polyimide Solution (Solution A)

### Preparation Example A-1

30 g of powder of the polyimide resin (a) obtained in Synthesis Example 1 was added in a powdery form into 75 g of dioxolane, and the mixture was stirred and dissolved to obtain a polyimide solution (A-1) (solid component (SC)=30% by weight).

### Preparation Example A-2

30 g of the polyimide resin (b) obtained in Synthesis Example 2 was added into 70 g of dioxolane, and was dissolved therein with stirring, thereby obtaining a polyimide solution (A-2) (solid component (SC)=30% by weight).

### Preparation Example A-3

30 g of powder of the polyimide resin (c) obtained in Synthesis Example 3 was added into 70 g of dioxolane, and was dissolved therein with stirring, thereby obtaining a polyimide solution (A-3) (solid component (SC)=30% by weight).

### Preparation Example of Cynate Ester Solution (Solution B)

### Preparation Example B-1

To 70 g of a mixture solvent in which dioxolane and toluene were mixed in a ratio of 8:2, added were 30 g of BA200 (product name; made by LONZA Ltd.; an oligomer in which 20% to 30% of all cyanate groups in a monomer have been converted into triazine rings), which is an oligomer of multifunctional cynate ester PRIMASET BADCY (product name; made by LONZA Ltd.), and 0.08 g of zinc (II) acetylacetonato. The mixture was then dissolved with stirring for 2 hours at a temperature in a range of 30° C. to 40° C. As a result, an cynate ester solution (B-1) (SC=30%) was obtained.

### Preparation Example B-2

To 70 g of a mixture solvent in which dioxolane and toluene were mixed in a ratio of 8:2, added were 30 g of phenolnovolak-type cynate ester PRIMASET PT-30 (product name; made by LONZA Ltd.; average recurring unit of a phenol novolak part: about 3), and 0.08 g of zinc (II) acetylacetonato. The mixture was then dissolved with stirring for 2 hours at a temperature in a range of 30° C. to 40° C. As a result, an cynate ester solution (B-2) (SC=30%) was obtained.

### Preparation Example B-3

To 700 g of a mixture solvent in which dioxolane and toluene were mixed in a ratio of 8:2, added were 300 g of multifunctional cynate ester PRIMASET BADCY (product name; made by LONZA Ltd.), and 0.012 g of zinc (II) acetylacetonato (0.012 parts by weight for 100 parts by weight of multifunctional cynate ester). The mixture was then dissolved with stirring for 2 hours at a temperature in a range of 30° C. to 40° C. As a result, an cynate ester solution (B-3) (SC=30%) was obtained.

### Preparation Example of Epoxy Resin Solution (Solution C)

### Preparation Example C-1

To 70 g of a mixture solvent in which dioxolane and toluene were mixed in a ratio of 8:2, added were 30 g of epoxy resin Epikote 1032H60 (product name; made by Yuka Shell Epoxy Co. Ltd.), and 9 g of 4,4′-diaminodiphenylsulfone. The mixture was then stirred and dissolved for 3 hours at a room temperature (at a temperature range of 20° C. to 30° C.). As a result, an epoxy resin solution (C-1) (SC=30%) was obtained.

### Preparation Example C-2

To 70 g of a mixture solvent in which dioxolane and toluene were mixed in a ratio of 8:2, added were 30 g of dicyclopentadiene-type epoxy resin EXA7200H (product name; made by Dainippon Ink And Chemicals, Incorporated), and 9 g of 4,4′-diaminodiphenylsulfone. The mixture was then dissolved with stirring for 3 hours at a room temperature (at a temperature in a range of 20° C. to 30° C.). As a result, an epoxy resin solution (C-2) (SC=30%) was obtained.

### Preparation Example C-3

To 70 g of a mixture solvent in which dioxolane and toluene were mixed in a ratio of 8:2, added were 30 g of alkoxy-group-including denatured epoxy resin (product name; made by Arakawa Chemical Industries, Ltd.), and 9 g of 4,4′-diaminodiphenylsulfone. The mixture was then dissolved with stirring for 3 hours at a room temperature (at a temperature in a range of 20° C. to 30° C.). As a result, an epoxy resin solution (C-3) (SC=30%) was obtained.

### Preparation Example of Resin Sheet

### Preparation Example 1

The polyimide solution (A-1) obtained in Preparation Example A-1 was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes. Thereafter, a sheet of polyimide resin was peeled off from the PET film so as to obtain a single-layered sheet of the polyimide resin (a). A glass-transition temperature of the product resin sheet was measured. The result is shown in Table 1.

### Preparation Example 2

The polyimide solution (A-2) obtained in Preparation Example A-2 was processed as in Preparation Example 1 so as to obtain a single-layered sheet of the polyimide resin (b). A glass-transition temperature of the product resin sheet was measured. The result is shown in Table 1.

### Preparation Example 3

The polyimide solution (A-3) obtained in Preparation Example A-2 was processed as in Preparation Example 1 so as to obtain a single-layered sheet of the polyimide resin (c). A glass-transition temperature of the product resin sheet was measured. The result is shown in Table 1.

TABLE 1

| | GRASS-TRANSITION |
|---|---|
| | TEMPERATURE (° C.) |
| POLYIMIDE RESIN OF | 160 |
| SYNTHESIS EXAMPLE 1 | |
| POLYIMIDE RESIN OF | 215 |
| SYNTHESIS EXAMPLE 2 | |
| POLYIMIDE RESIN OF | 165 |
| SYNTHESIS EXAMPLE 3 | |

### Examples and Comparative Examples

Described below is a first example of the thermosetting resin composition of the present invention, in which only (B) the multifunctional cynate ester was included as a thermosetting component. Among the following Examples 1 to 5 and Comparative Examples 1 and 2, those cases in which only (A) the polyimide resin and (B) multifunctional cynate ester out of the necessary components (A) to (C) were included are labeled as examples, and the other cases are labeled as comparative examples.

### Example 1

80 g of the polyimide solution (A-1) obtained in Preparation Example (A-1) was mixed with 20 g of the cynate ester solution (B-1) obtained in Preparation Example (B-1) so as to prepare a solution (resin solution) including the thermosetting resin composition of the present invention (see Table 2).

Next, the product resin solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes to obtain a two-layered resin sheet using the PET film as a substrate. Thereafter, the PET film was peeled off from the resin sheet so as to obtain a single-layered resin sheet. Thickness of the single-layered resin sheet obtained was 50 μm.

The resin sheet obtained was sandwiched by flat-rolled copper foil (product name BHY-22B-T under Japan Energy Corporation) of 18 μm thickness, so that resin surfaces and rough surfaces of the copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil).

Strength of the copper foil against peeling was measured by using the copper foil laminate obtained. Furthermore, by using a sheet obtained by entirely removing the copper foil from the copper foil laminate, dielectric properties and a thermal property were evaluated. The result is shown in Table 3.

### Examples 2 to 5

Resin solutions, resin sheets and metal foil laminates were obtained by the same method and under the same conditions as those in Example 1, except that the polyimide solutions A-1 or A-2, and one of the cynate ester solutions B-1 to B-3 were mixed in blending ratios shown in Table 2. The resin solutions, resin sheets and metal foil laminates were measured and evaluated in terms of strength of the copper foil against peeling, dielectric properties, and a thermal property. The result is shown in Table 3.

### Comparative Example 1

80 g of the polyimide solution (A-1) obtained in Preparation Example A-1 was mixed with 20 g of the epoxy resin solution (C-1) obtained in Preparation Example C-1 to prepare a solution (resin solution) including the thermosetting resin composition (see Table 2).

Next, the product resin solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes so as to obtain a two-layered resin sheet using the PET film of the present invention as a substrate. Thereafter, the PET film was peeled off from the resin sheet so as to obtain a single-layered resin sheet. Thickness of the single-layered resin sheet obtained was 50 μm.

The resin sheet obtained was sandwiched by flat-rolled copper foil (product name BHY-22B-T under Japan Energy Corporation) of 18 μm thickness, so that resin surfaces and rough surfaces of the copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil.

Strength of the copper foil against peeling was measured using the copper foil laminate obtained. Furthermore, using a sheet obtained by entirely removing the copper foil from the copper foil laminate, a dielectric properties and a thermal property were evaluated. The result is shown in Table 3.

### Comparative Example 2

A resin solution, a resin sheet and a metal foil laminate were obtained by the same method and under the same conditions as Comparative Example 1, except that the polyimide solution A-2 was used instead of the polyimide solution A-1. The resin solution, resin sheet and metal foil laminate were measured and evaluated in terms of strength of the copper foil against peeling, dielectric properties, and a thermal property. The result is shown in Table 3.

TABLE 2

| | | | SOLUTION A: |
|---|---|---|---|
| | TYPE OF | TYPE OF | SOLUTION B |
| | SOLUTION A | SOLUTION B | (WEIGHT RATIO) |
| EXAMPLE 1 | A-1 | B-1 | 80:20 |
| EXAMPLE 2 | A-1 | B-1 | 30:70 |
| EXAMPLE 3 | A-1 | B-2 | 80:20 |
| EXAMPLE 4 | A-2 | B-1 | 80:20 |
| EXAMPLE 5 | A-2 | B-3 | 60:40 |
| COMPARATIVE | A-1 | C-1 | 80:20 |
| EXAMPLE 1 | | | |
| COMPARATIVE | A-2 | C-1 | 80:20 |
| EXAMPLE 2 | | | |

TABLE 3

| | | DIELECTRIC PROPERTIES | | | |
|---|---|---|---|---|---|
| | | (DIELECTRIC CONSTANT/ | | | COEFFICIENT |
| | ADHESION | DIELECTRIC | | | OF THERMAL |
| | STRENGTH | DISSIPATION FACTOR) | | | EXPANSION |
| | (N/cm) | 3 GHz | 5 GHz | 10 GHz | (ppm) |
| EX 1 | 9 | 2.9/0.004 | 2.9/0.004 | 2.9/0.005 | 105 |
| EX 2 | 7 | 3.0/0.009 | 2.8/0.009 | 2.8/0.010 | 88 |
| EX 3 | 10 | 3.0/0.005 | 2.8/0.005 | 2.9/0.005 | 120 |
| EX 4 | 10 | 2.9/0.007 | 2.9/0.007 | 2.9/0.006 | 77 |
| COMP EX 5 | 9 | 2.9/0.008 | 2.8/0.009 | 2.8/0.009 | 124 |
| COMP EX 1 | 12 | 3.3/0.012 | 3.2/0.012 | 3.2/0.013 | 490 |
| COMP EX 2 | 11 | 3.2/0.013 | 3,2/0.013 | 3.1/0.014 | 401 |

EX: EXAMPLE
COMP EX: COMPARATIVE EXAMPLE

As shown above, even if (B) the multifunctional cynate ester was included as a thermosetting component, sufficiently excellent properties were attained. On the other hand, in Comparative Examples, in which a conventionally used epoxy resin was used as (C) the epoxy resin, the coefficients of thermal expansion were high.

Described below is a next example of the thermosetting resin composition of the present invention, in which only (B) the multifunctional cynate ester was included as a thermosetting component, and a blending ratio of (B) the multifunctional cynate ester was controlled to a certain range, so as to attain an excellent balance between PCT resistance and processability. Among the following Examples 6 to 12 and Comparative Examples 3 and 4, those cases in which only (A) the polyimide resin and (B) multifunctional cynate ester were included, and a high adhesion strength after PCT tests were attained are labeled as examples, and the other cases are labeled as comparative examples, even if they are within the scope of the present invention.

### Example 6

90 g of the polyimide solution (A-1) obtained in Preparation Example A-1 was mixed with 10 g of the cynate ester solution (B-1) obtained in Preparation Example B-1 so as to prepare a solution including the thermosetting resin composition of the present invention (see Table 4).

Next, the product resin solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes so as to obtain a two-layered resin sheet using the PET film of the present invention as a substrate. Thereafter, the PET film was peeled off from the resin sheet to obtain a single-layered resin sheet. Thickness of the single-layered resin sheet obtained was 50 μm.

The resin sheet obtained was sandwiched by flat-rolled copper foil (product name BHY-22B-T under Japan Energy Corporation) of 18 μm thickness, so that resin surfaces and rough surfaces of the copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil).

Strength of the copper foil against peeling was measured using the copper foil laminate obtained. Furthermore, using a sheet obtained by entirely removing the copper foil from the copper foil laminate, dielectric properties and a thermal property were evaluated. The result is shown in Table 5.

### Examples 7 to 12

Resin solutions, resin sheets and metal foil laminates were obtained by the same method and under the same conditions as those in Example 6, except that one of the polyimide solutions A-1 to A-3, one of the cynate ester solutions B-1 and B-2, and the other components were mixed at blending ratios shown in Table 4. The resin solutions, resin sheets and metal foil laminates were measured and evaluated in terms of strength of the copper foil against peeling, dielectric properties, and a thermal property. The result is shown in Table 5.

### Comparative Example 3

A resin solution, a resin sheet and a metal foil laminate were obtained by the same method and under the same conditions as those in Example 1, except that 80 g of the polyimide solution (A-1) was mixed with 20 g of the cynate ester solution (B-1). The resin solution, resin sheet and metal foil laminate were measured and evaluated in terms of strength of the copper foil against peeling, dielectric properties, and a thermal property. The result is shown in Table 5.

### Comparative Example 4

A resin solution, a resin sheet and a metal foil laminate were obtained by the same method and under the same conditions as those in Comparative Example 3, except that 98 g of the polyimide solution (A-1) was mixed with 2 g of the cynate ester solution (B-1). The resin solution, resin sheet and metal foil laminate were measured and evaluated in terms of strength of the copper foil against peeling, dielectric properties, and a thermal property. The result is shown in Table 5.

TABLE 4

| | | | SOLUTION A: | HARDENING |
|---|---|---|---|---|
| | TYPE OF | TYPE OF | SOLUTION B | CATALYST |
| | SOLUTION | SOLUTION | (WEIGHT | (WEIGHT PART/ |
| | A | B | RATIO) | COMPONENT (B)) |
| EX 6 | A-1 | B-1 | 90:10 | 0 |
| EX 7 | A-1 | B-1 | 90:10 | 0.003 |
| EX 8 | A-1 | B-2 | 90:10 | 0 |
| EX 9 | A-2 | B-1 | 90:10 | 0 |
| EX 10 | A-3 | B-1 | 90:10 | 0 |
| EX 11 | A-1 | B-1 | 86:14 | 0 |
| EX 12 | A-1 | B-1 | 94:6 | 0 |
| COMP | A-1 | B-1 | 80:20 | 0 |
| EX 3 | | | | |
| COMP | A-1 | B-1 | 98:2 | 0 |
| EX 4 | | | | |

EX: EXAMPLE
COMP EX: COMPARATIVE EXAMPLE

TABLE 5

| | ADHESION | ADHESION | DIELECTRIC PROPERTIES | | |
|---|---|---|---|---|---|
| | STRENGTH | STRENGTH | (DIELECTRIC CONSTANT/ | | |
| | [BEFORE | [AFTER | DIELECTRIC | | |
| | PCT] | PCT] | DISSIPATION FACTOR) | | |
| | (N/cm) | (N/cm) | 3 GHz | 5 GHz | 10 GHz |
| EX 6 | 14 | 9 | 2.8/0.004 | 2.8/0.004 | 2.7/0.005 |
| EX 7 | 14 | 10 | 2.8/0.009 | 2.8/0.004 | 2.8/0.005 |
| EX 8 | 13 | 9 | 2.9/0.005 | 2.9/0.005 | 2.9/0.006 |
| EX 9 | 10 | 7 | 2.9/0.006 | 2.9/0.006 | 2.9/0.007 |
| EX 10 | 13 | 9 | 2.7/0.005 | 2.7/0.005 | 2.7/0.006 |
| EX 11 | 16 | 6 | 2.9/0.006 | 2.9/0.007 | 2.8/0.007 |
| EX 12 | 12 | 11 | 2.9/0.007 | 2.9/0.007 | 2.9/0.007 |
| COMP EX 3 | 9 | 3 | 2.9/0.004 | 2.9/0.004 | 2.9/0.005 |
| COMP EX 4 | 2 | 2 | 2.7/0.012 | 2.7/0.004 | 2.6/0/004 |

EX: EXAMPLE
COMP EX: COMPARATIVE EXAMPLE

As shown above, if the mixing ratio (A/B) of (A) the polyimide resin and (B) the multifunctional cynate ester was within a range of 95/5 to 85/15 by weight, high strength of the copper against peeling were maintained after the PCT tests. On the other hand, if the mixing ratio was not within the range above, the strength of the copper against peeling were drastically decreased after the PCT tests.

Described below is a next example of the thermosetting resin composition of the present invention, in which only (C) the epoxy resin was included as a thermosetting component. Among the following Examples 13 to 16 and Comparative Examples 5 to 7, those cases in which (A) the polyimide resin and (C) the epoxy resin were included, and high adhesion strength were attained, are labeled as examples, and the other cases are labeled as comparative examples.

### Example 13

35 g of the polyimide resin (a) obtained in Synthesis Example 1, 15 g of dicyclopentadiene-type epoxy resin EXA7200H (product name; made by Dainippon Ink And Chemicals, Incorporated), and, as a curing accelerator, 0.015 g of 2-ethyl-4-methylimidazole were dissolved in dioxolane so as to obtain a resin solution.

Next, the product solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes so as to obtain a two-layered resin sheet using the PET film of the present invention as a substrate. Thereafter, the PET film was peeled off from the resin sheet to obtain a single-layered resin sheet. Thickness of the single-layered resin sheet obtained was 50 μm.

The resin sheet obtained was sandwiched by flat-rolled copper foil (product name BHY-22B-T under Japan Energy Corporation) of 18 μm thickness, so that resin surfaces and rough surfaces of the copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil).

Strength of the copper foil against peeling was measured using the copper foil laminate obtained. Furthermore, using a sheet obtained by entirely removing the copper foil from the copper foil laminate, a dielectric properties and a thermal property were evaluated. The result is shown in Table 6.

### Example 14

35 g of the polyimide resin (b) obtained in Synthesis Example 2, 15 g of dicyclopentadiene-type epoxy resin EXA7200H (product name; made by Dainippon Ink And Chemicals, Incorporated), and, as a curing accelerator, 0.015 g of 2-ethyl-4-methylimidazole were dissolved in dioxolane so as to obtain a resin solution.

The resin solution obtained was processed by the same method under the same conditions as those in Example 13 to obtain a resin sheet and a metal foil laminate. The resin sheet and metal foil laminate were measured and evaluated in terms of strength of the copper against peeling and dielectric properties. The result is shown in Table 6.

### Example 15

40 g of the polyimide resin (a) obtained in Synthesis Example 1, 10 g of alkoxy-group-including silane denatured epoxy resin Compoceran E103 (product name; made by Arakawa Chemical Industries, Ltd.), and, as a curing accelerator, 0.015 g of 2-ethyl-4-methylimidazole were dissolved in dioxolane so as to obtain a resin solution.

The resin solution obtained was processed by the same method under the same conditions as those in Example 13 so as to obtain a resin sheet and a metal foil laminate. The resin sheet and metal foil laminate were measured and evaluated in terms of strength of the copper against peeling and dielectric properties. The result is shown in Table 6.

### Example 16

30 g of the polyimide resin (a) obtained in Synthesis Example 1, 20 g of dicyclopentadiene-type epoxy resin EXA7200H (product name; made by Dainippon Ink And Chemicals, Incorporated), and 1 g of naphthalene-type epoxy resin EPICLON EXA-4700 (product name; made by Dainippon Ink And Chemicals, Incorporated) were dissolved in dioxolane so as to obtain a resin solution.

The resin solution obtained was processed by the same method under the same conditions as those in Example 13 to obtain a resin sheet and a metal foil laminate. The resin sheet and metal foil laminate were measured and evaluated in terms of strength of the copper against peeling and dielectric properties. The result is shown in Table 6.

### Comparative Example 5

30 g of the polyimide resin (a) obtained in Synthesis Example 1, 20 g of bisphenol A-type epoxy resin Epikote 828 (product name; made by Yuka Shell Epoxy Co. Ltd.), and, as a curing accelerator, 0.01 g of 2-ethyl-4-methylimidazole were dissolved in dioxolane so as to obtain a resin solution.

The resin solution obtained was processed by the same method under the same conditions as those in Example 13 to obtain a resin sheet and a metal foil laminate. The resin sheet and metal foil laminate were measured and evaluated in terms of strength of the copper against peeling and dielectric properties. The result is shown in Table 6.

### Comparative Example 6

40 g of the polyimide resin (b) obtained in Synthesis Example 2, 10 g of phenolnovolak-type epoxy resin Epikote 1032H60 (product name; made by Yuka Shell Epoxy Co. Ltd.), and, as a curing accelerator, 0.01 g of 2-ethyl-4-methylimidazole were dissolved in dioxolane so as to obtain a resin solution.

The resin solution obtained was processed by the same method under the same conditions as those in Example 13 to obtain a resin sheet and a metal foil laminate. The resin sheet and metal foil laminate were measured and evaluated in terms of strength of the copper against peeling and dielectric properties. The result is shown in Table 6.

### Comparative Example 7

35 g of Platabond M1276 (product name; made by Japan Rilsan), which was a copolymer nylon, 15 g of dicyclopentadiene-type epoxy resin EXA7200H (product name; made by Dainippon Ink And Chemicals, Incorporated), 1 g of diaminodiphenylsulfone as a curing agent, and, as a curing accelerator, 0.015 g of 2-ethyl-4-methylimidazole were dissolved in dioxolane to obtain a resin solution.

The resin solution obtained was processed by the same method under the same conditions as those in Example 13 to obtain a resin sheet and a metal foil laminate. The resin sheet and metal foil laminate were measured and evaluated in terms of strength of the copper against peeling and dielectric properties. The result is shown in Table 6.

TABLE 6

| | | | DIELECTRIC PROPERTIES | | |
|---|---|---|---|---|---|
| | ADHESION | ADHESION | (DIELECTRIC CONSTANT/ | | |
| | STRENGTH | STRENGTH | DIELECTRIC | | |
| | [20° C.] | [150° C.] | DISSIPATION FACTOR) | | |
| | (N/cm) | (N/cm) | 3 GHz | 5 GHz | 10 GHz |
| EX 13 | 11 | 8 | 3.1/0.014 | 3.1/0.013 | 3.0/0.014 |
| EX 14 | 11 | 8 | 3.2/0.012 | 3.2/0.012 | 3.2/0.012 |
| EX 15 | 10 | 7 | 3.0/0.010 | 3.0/0.010 | 2.9/0.011 |
| EX 16 | 10 | 7 | 3.0/0.009 | 3.0/0.009 | 3.0/0.009 |
| COMP EX 5 | 11 | 8 | 3.4/0.022 | 3.4/0.022 | 3.3/0.024 |
| COMP EX 6 | 10 | 9 | 3.2/0.018 | 3.2/0.018 | 3.2/0.019 |
| COMP EX 7 | 12 | 1 | 3.3/0.020 | 3.3/0.020 | 3.3/0.020 |

EX: EXAMPLE
COMP EX: COMPARATIVE EXAMPLE

As shown above, if the mixing ratio (A/B) of (A) the polyimide resin and (B) the multifunctional cynate ester was within a range of 95/5 to 85/15 by weight, high strength of the copper against peeling were maintained after the PCT tests. On the other hand, if the mixing ratio was not within the range above, the strength of the copper against peeling was drastically decreased after the PCT tests.

As shown above, even if the suitable epoxy resin was included as (C) the epoxy resin, sufficiently excellent properties were attained. On the other hand, in Comparative Examples, in which a conventionally used epoxy resin was used as (C) the epoxy resin, the adhesion strength was insufficient, and low dielectric properties were not attained.

Described below is a next example of the thermosetting resin composition of the present invention, in which both (B) the multifunctional cynate ester and (C) epoxy resin were included. Among the following Examples 17 to 23 and Comparative Examples 8 to 13, those cases in which (A) the polyimide resin, (B) the multifunctional cynate ester, and (C) the epoxy resin were included are labeled as examples, and the other cases are labeled as comparative examples, even if they are within the scope of the present invention.

### Comparative Example 17

80 g of the polyimide solution (A-1) obtained in Preparation Example A-1.15 g of the cynate ester solution (B-1) obtained in Preparation Example B-1, and 5 g of the epoxy resin solution (C-1) obtained in Preparation Example C-1 were mixed so as to prepare a solution (resin solution) including the thermosetting resin composition of the present invention (see Table 7).

Next, the product solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes to obtain a two-layered resin sheet using the PET film of the present invention as a substrate. Thereafter, the PET film was peeled off from the resin sheet so as to obtain a single-layered resin sheet. Thickness of the single-layered resin sheet obtained was 50 μm.

The resin sheet obtained was sandwiched by flat-rolled copper foil (product name BSHY-22B-T under Japan Energy Corporation) of 18 μm thickness, so that resin surfaces and rough surfaces of copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil).

Strength of the copper foil against peeling was measured using the copper foil laminate obtained. Furthermore, using a sheet obtained by entirely removing the copper foil from the copper foil laminate, a dielectric properties and a thermal property were evaluated. The result is shown in Table 8.

### Examples 18 to 23

Resin solutions, resin sheets and metal foil laminates were obtained by the same method and under the same conditions as those in Example 17, except that one of the polyimide solutions A-1 to A-3, one of the cynate ester solutions B-1 and B-2, and one of the epoxy resin solutions C-1 to C-3 were mixed at blending ratios shown in Table 7. The resin solutions, resin sheets and metal foil laminates were measured and evaluated in terms of strength of the copper foil against peeling, dielectric properties, and a thermal property. The result is shown in Table 8.

### Comparative Example 3

A resin solution, a resin sheet and a metal foil laminate were obtained by the same method and under the same conditions as those in Example 17, except that 80 g of the polyimide solution (A-1) obtained in Preparation Example 1 was mixed with 20 g of the cynate ester solution (B-1) obtained in Preparation Example B-1. The resin solution, resin sheet and metal foil laminate were measured and evaluated in terms of strength of the copper foil against peeling, dielectric properties, and a thermal property. The result is shown in Table 2.

### Comparative Examples 9 to 11

Resin solutions, resin sheets and metal foil laminates were obtained by the same method and under the same conditions as those in Example 17, except that one of the polyimide solutions A-1 and A-2 was mixed with one of the cynate ester solutions B-1 and B-2 at blending ratios shown in Table 7. The resin solutions, resin sheets and metal foil laminates were measured and evaluated in terms of strength of the copper foil against peeling, dielectric properties, and a thermal property. The result is shown in Table 8.

### Comparative Example 12

80 g of the polyimide solution (A-1) obtained in Preparation Example A-1 was mixed with 20 g of the epoxy resin solution (C-3) obtained in Preparation Example C-3 to prepare a solution (resin solution) including the thermosetting resin composition of the present invention (see Table 7).

Next, the product solution was flow-casted on a surface of a 125 μm PET film (product name Cerapeel HP under Toyo Metallizing Co., Ltd.) used as a supporting body. Then, the PET film was heated by a hot-air oven at 60° C., 80° C., 100° C., 120° C., and then 140° C. for 5 minutes each. The PET film was then dried with heating at 150° C. for 5 minutes to obtain a two-layered resin sheet using the PET film of the present invention as a substrate. Thereafter, the PET film was peeled off from the resin sheet to obtain a single-layered resin sheet. Thickness of the single-layered resin sheet obtained was 50 μm.

The resin sheet obtained was sandwiched by flat-rolled copper foil (product name BHY-22B-T under Japan Energy Corporation) of 18 μm thickness, so that resin surfaces and rough surfaces of copper foil contact each other. Then, heat and pressure were applied for 1 hour at 200° C. under a pressure of 3 MPa. Thereafter, heat processing was performed for 2 hours at 200° C. in the hot-air oven so as to cure the thermosetting resin composition. The product was a copper foil laminate (having a structure in which the single-layered resin sheet was sandwiched by the flat-rolled copper foil.

Strength of the copper foil against peeling was measured using the copper foil laminate obtained. Furthermore, using a sheet obtained by entirely removing the copper foil from the copper foil laminate, a dielectric properties and a thermal property were evaluated. The result is shown in Table 8.

### Comparative Example 13

A resin solution, a resin sheet and a metal foil laminate were obtained by the same method and under the same conditions as those in Comparative Example 13, except that the polyimide solution A-2 was used instead of the polyimide solution A-1. The resin solution, resin sheet and metal foil laminate were measured and evaluated in terms of strength of the copper foil against peeling, dielectric properties, and a thermal property. The result is shown in Table 8.

TABLE 7

| | | | | SOLUTION A: |
|---|---|---|---|---|
| | TYPE OF | TYPE OF | TYPE OF | SOLUTION B: |
| | SOLUTION | SOLUTION | SOLUTION | SOLUTION C |
| | A | B | C | (WEIGHT RATIO) |
| EX 17 | A-1 | B-1 | C-1 | 80:15:5 |
| EX 18 | A-1 | B-1 | C-1 | 60:30:10 |
| EX 19 | A-1 | B-2 | C-1 | 80:15:5 |
| EX 20 | A-2 | B-1 | C-1 | 80:15:5 |
| EX 21 | A-3 | B-1 | C-1 | 80:15:5 |
| EX 22 | A-1 | B-1 | C-2 | 80:15:5 |
| EX 23 | A-1 | B-1 | C-3 | 80:15:5 |
| COMP | A-1 | B-1 | — | 80:20:0 |
| EX 8 | | | | |
| COMP | A-1 | B-1 | — | 60:40:0 |
| EX 9 | | | | |
| COMP | A-1 | B-2 | — | 80:20:0 |
| EX 10 | | | | |
| COMP | A-2 | B-1 | — | 80:20:0 |
| EX 11 | | | | |
| COMP | A-1 | — | C-1 | 80:0:20 |
| EX 12 | | | | |
| COMP | A-2 | — | C-1 | 80:0:20 |
| EX 13 | | | | |

EX: EXAMPLE
COMP EX: COMPARATIVE EXAMPLE

TABLE 8

| | ADHESION | ADHESION | DIELECTRIC PROPERTIES | | | |
|---|---|---|---|---|---|---|
| | STRENGTH | STRENGTH | (DIELECTRIC CONSTANT/ | | | |
| | [NORMAL | [AFTER | DIELECTRIC | | | |
| | STATE] | PCT] | DISSIPATION FACTOR) | | | CTE |
| | (N/cm) | (N/cm) | 3 GHz | 5 GHz | 10 GHz | (ppm) |
| EX 17 | 10 | 7 | 3.0/0.006 | 3.0/0.006 | 3.0/0.006 | 120 |
| EX 18 | 8 | 6 | 3.1/0.010 | 3.1/0.011 | 3.1/0.010 | 95 |
| EX 19 | 10 | 8 | 3.0/0.006 | 3.1/0.007 | 3.0/0.006 | 136 |
| EX 20 | 10 | 7 | 3.0/0.008 | 3.0/0.008 | 3.0/0.008 | 85 |
| EX 21 | 10 | 8 | 2.9/0.009 | 2.9/0.009 | 2.8/0.010 | 90 |
| EX 22 | 9 | 8 | 2.9/0.007 | 2.9/0.007 | 2.9/0.007 | 114 |
| EX 23 | 12 | 9 | 2.8/0.007 | 2.8/0.007 | 2.8/0.007 | 102 |
| COMP EX 8 | 9 | 3 | 2.9/0.004 | 2.9/0.004 | 2.9/0.005 | 105 |
| COMP EX 9 | 7 | 2 | 3.0/0.009 | 2.8/0.009 | 2.8/0.010 | 88 |
| COMP EX 10 | 10 | 3 | 3.0/0.005 | 2.9/0.005 | 2.9/0.005 | 120 |
| COMP EX 11 | 10 | 3 | 2.9/0.007 | 2.9/0.007 | 2.9/0.006 | 77 |
| COMP EX 12 | 12 | 10 | 3.3/0.012 | 3.2/0.012 | 3.2/0.013 | 490 |
| COMP EX 13 | 11 | 8 | 3.3/0.013 | 3.2/0.013 | 3.1/0.014 | 401 |

EX: EXAMPLE
COMP EX: COMPARATIVE EXAMPLE
CTE: COEFFICIENT OF THERMAL EXPANSION

As shown above, even in cases in which (B) the multifunctional cynate ester and (C) the epoxy resin were included as thermosetting components, sufficiently excellent properties were attained. On the other hand, in Comparative Examples, in which only one of (B) the multifunctional cynate ester and (C) the epoxy resin was used as a thermosetting component, there were cases in which the adhesion strength was insufficient.

As described above, the thermosetting composition of the present invention at least includes (A) the polyimide resin, and (B) the multifunctional cynate ester and/or (C) the epoxy resin, and, depending on intended uses, also includes (D) other component.

More specifically, in the present invention, at least one of (B) the multifunctional cynate ester and (C) the epoxy resin is blended as a thermosetting component with (A) the polyimide resin, which is a primary component.

It is preferable that (A) the polyimide resin used here is a soluble polyimide obtained by reacting, with a diamine, acid dianhydride represented by general formula (1), the acid dianhydride having an ether bond. As (B) the multifunctional cynate ester, a monomer represented by general formula (6) and/or an oligomer thereof is preferably used. As (C) the epoxy resin, an epoxy resin having a dicyclopentadiene bone structure and/or an alkoxy-group-including silane denatured epoxy resin (suitable epoxy resin) is preferably used.

In blending, with (A) the polyimide resin, (B) the multifunctional cynate ester, which is a thermosetting component, blending/mixing proportion of (A) the polyimide resin and (B) the multifunctional cynate ester are respectively adjusted to predetermined ranges. It is preferable that a mixing ratio of the components' (A) and (B) is 95/5 to 85/15 by weight. Here, it is preferable that, after curing, adhesion strength of the thermosetting resin composition with copper foil is not weaker than 5N/cm before and after PCT processing. Moreover, it is preferable that a glass-transfer temperature of (A) the polyimide resin is not higher than 250° C. It is preferable that the component (C) is mixed in also in a certain ratio by weight.

In other words, although it is sufficient that the thermosetting resin composition of the present invention includes the three components (A) polyimide resin, (B) multifunctional cynate ester, and/or (C) epoxy resin, it is preferable that, specifically, (A) is the soluble polyimide represented by general formula (1), (B) is the multifunctional cynate ester represented by general formula (6), and (C) is at least one of the epoxy resins represented by general formulas (8), (9), and (10). It is preferable that the thermosetting resin composition includes at least two of the three specific components.

According to this arrangement, by using the soluble polyimide as (A) the polyimide resin, it is possible to attain a specific compatibility with (B) the multifunctional cynate ester. Moreover, an excellent compatibility can be attained at a broad range of mixing ratios. Therefore, various properties of the thermosetting resin composition of the present invention, such as processability, can be improved without deteriorating excellent dielectric properties (without increasing a dielectric constant and a dielectric dissipation factor) of (A) the polyimide resin. Furthermore, it is possible to improve such properties as heat resistance. Moreover, because a glass-transfer temperature of the thermosetting resin composition of the present invention is relatively low as compared with that of a conventional thermoplastic polyimide resin type blended adhesive material, the thermosetting resin composition can adhere to an adherend at a lower temperature. As a result, the thermosetting resin composition of the present invention is excellent also in such properties as processability in performing bonding, and handleability.

Moreover, by using the monomer and/or the oligomer thereof as (B) the multifunctional cynate ester, it is possible to mix (B) the multifunctional cynate ester, as well as (C) the epoxy resin, in such an amount that is sufficient for (A) the polyimide resin. The thermosetting resin composition of the present invention which sufficiently contains (B) the multifunctional cynate ester is excellent in a balance of such properties as dielectric properties, adhesion, processability, and heat resistance, as compared with a conventional epoxy-type adhesive material and a blended adhesive material in which a polyimide/epoxy resin is mixed in. In particular, it is possible to improve the processability, especially that of when bonding is performed using such as a pressing apparatus or laminating apparatus. Furthermore, it is possible to prevent deterioration of the excellent dielectric properties of (A) the polyimide resin, and to attain PCT resistance.

By using the suitable epoxy resin as (C) the epoxy resin, it is possible to prevent deterioration of the excellent dielectric properties of the polyimide resin, and to attain such adhesion that has excellent environmental resistance, even if a sufficient amount of the epoxy resin is mixed with the polyimide resin, thereby improving the processability of the thermosetting resin composition obtained. Moreover, the thermosetting resin composition of the present invention which sufficiently includes (C) the epoxy resin can attain, even after processed into a sheet, such adhesion that has excellent environmental resistance.

In addition, by setting the mixing ratios of the components (A), (B), and (C) as described above, it is possible to improve not only the PCT resistance, but also the processability. In particular, it is possible to attain the processability in bonding process in which a pressing apparatus, laminating apparatus, or the like is used.

The invention being thus described, it will be obvious that the same may be varied in many ways. Such variations are not to be regarded as a departure from the spirit and scope of the present invention, and all such modifications as would be obvious to one skilled in the art are intended to be within the scope of the following claims.

### INDUSTRIAL APPLICABILITY

As described above, in the present invention, the thermosetting resin composition, and the laminate and the circuit substrate using the thermosetting resin composition are excellent in dielectric properties in GHz frequency range, processability, heat resistance, and adhesion, and are also excellent in adhesion, and especially PCT resistance.

Therefore, the present invention can sufficiently solve the problems caused by the conventional blended material. Therefore, the present invention is suitable for manufacturing circuit substrates, such as laminates of FPCs and build-up wiring substrates that require heat resistance, low dielectric constant, and low dielectric properties such as a low dielectric constant and a low dielectric dissipation factor.

As such, the present invention can be used in high polymer chemical industries to manufacture various resins and resin compositions. In addition, the present invention can be used in applied chemical industries so as to manufacture products such as blended adhesive materials, resin sheets, laminates, and the like. Furthermore, the present invention can be used in fields such as production of electrical/electronic parts such as FPCs and build up wiring substrates, and in fields such as production of electrical/electronic devices using the electrical/electronic parts.

1-21. (canceled)

22. A thermosetting resin composition, comprising:
(A) a polyimide resin;
(B) a multifunctional cynate ester; and
(C) an epoxy resin, which are thermosetting components,
(A) the polyimide resin being soluble polyimide obtained by reacting, with a diamine, at least one of acid dianhydride represented by the following general formula (1): 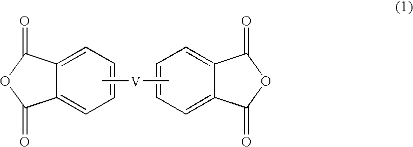
where V is a divalent group selected from the group consisting of —O—, —CO—, —O-T-O—, and COO-T-OCO—; and T is a divalent organic group; wherein
composition ratios of (A) the polyimide resin, (B) the multifunctional cynate ester, and (C) the epoxy resin are within the following ranges, respectively:
C_{A}/(C_{A}+C_{B}+C_{C})=0.5 to 0.96;
C_{B}/(C_{A}+C_{B}+C_{C})=0.02 to 0.48; and
C_{C}/(C_{A}+C_{B}+C_{C})=0.002 to 0.48,
where C_{A} is a weight of all components of (A) the polyimide resin; C_{B} is a weight of all components of (B) the multifunctional cynate ester; and C_{C} is a weight of all components of (C) the epoxy resin.

23. The thermosetting resin composition as set forth in claim 22, wherein:
the diamine is at least one of diamines represented by the following general formula (4): 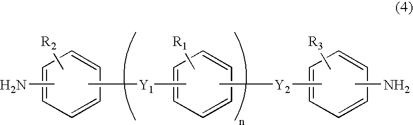
where Y₁ and Y₂ are independently —C(.═O) —, —SO₂—, —O—, —S—, —(CH₂)ₘ—, —NHCO—, —C(CH₃)₂, —C(CF₃)₂—, —C(═O)O—, or a single bond (direct bond); R₁, R₂, and R₃ are independently hydrogen, a halogen group, or an alkyl group whose carbon number is not less than 1 and not more than 5; and m and n are integers not less than 1 and not more than 5.

24. The thermosetting resin composition as set forth in claim 22, wherein:
the diamine is a diamine represented by the following general formula (5): 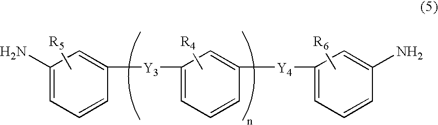
where Y₃ and Y₄ are independently —C(═O) —, —SO₂—, —O—, —S—, —(CH₂)ₘ—, —NHCO—, —C(CH₃)₂, —C(CF₃)₂—, —C(—O)O—, or a single bond (direct bond); R₄, R₅, and R₆ are independently hydrogen, a halogen group, or an alkyl group whose carbon number is not less than 1 and not more than 4; and m and n are integers not less than 1 and not more than 5.

25. The thermosetting resin composition as set forth in claim 22, wherein:
the diamine is at least one of diamines including a hydroxyl group and/or a carboxyl group.

26. The thermosetting resin composition as set forth in claim 22, wherein:
the acid dianhydride represented by general formula (1) is such that T in general formula (1) is an organic group represented by the following group (2): 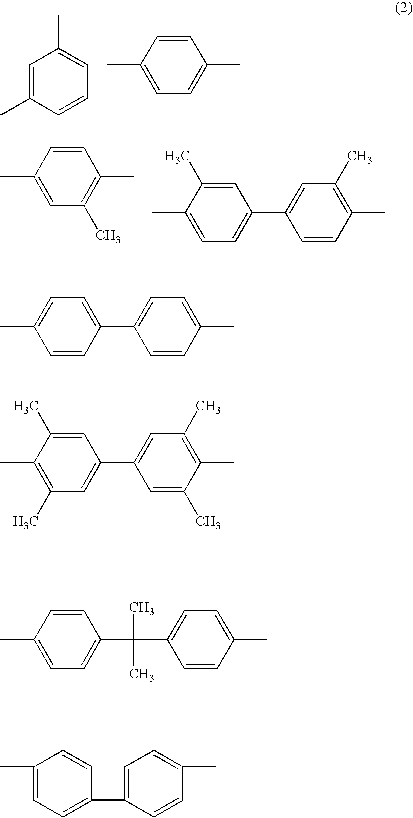
or an organic group represented by the following general formula (3): 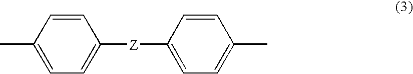
where Z is a divalent group selected from the group consisting of —C_{Q}H_{2Q}—, —C(—O) —, —SO₂—, —O—, and —S—; and Q is an integer not less than 1 and not more than 5.

27. The thermosetting resin composition as set forth in claim 22, wherein:
a glass-transition temperature of the soluble polyimide used as (A) the polyimide resin is not higher than 250° C.

28. The thermosetting resin composition as set forth in claim 22, wherein:
(B) the multifunctional cynate ester is at least one of a multifunctional cynate ester and/or an oligomer thereof,
the multifunctional cynate ester being selected from compounds represented by the following general formula (6): 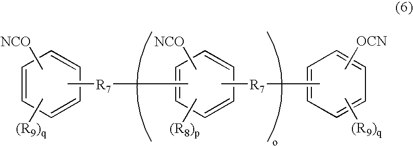
where R₇ is selected from —CH₂—, —C(CH₃)₂—, —C(CF₃)₂—, —CH(CH₃)—, —CH(CF₃), —SO₂—, —S—, —O—, and a bivalent organic group having at least one of a single bond, an aromatic ring, and an aliphatic ring; R₈ and R₉ are identically or differently selected from —H, —CH₃, and —CF₃; o is an integer not less than 0 and not more than 7; and p and q are identical or different integers not more than 0 and not less than 3.

29. The thermosetting resin composition as set forth in claim 22, wherein;
(B) the multifunctional cynate ester is at least one of compounds represented by the following group (7); 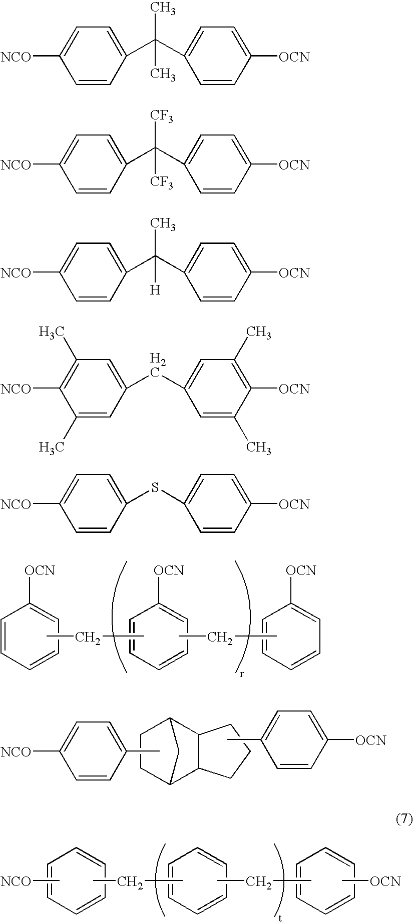
where r and t are integers not less than 0 and not more than 5.

30. The thermosetting resin composition as set forth in claim 22, wherein:
(C) the epoxy resin is at least one an epoxy resin and/or an alkoxy-group-including silane denatured epoxy resin,
the epoxy resin being represented by the following general formulas (8), (9) and (10): 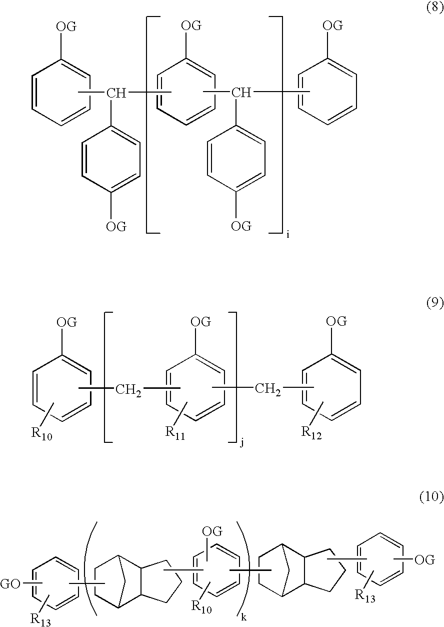
where G is an organic group represented by the following structural formula: 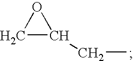
i, j, and k are integers respectively not less than 0 and not more than 5; and R₁₀, R₁₁, R₁₂, and R₁₃ are independently a hydrogen atom or an alkyl group whose carbon number is 1 to 4.

31. A thermosetting resin composition as set forth in claim 22, further comprising;
at least one of a curing catalyst and a curing agent,
the curing catalyst accelerating curing of (B) the multifunctional cynate ester, and
the curing agent accelerating curing of (C) the epoxy resin.

32. The thermosetting resin composition as set forth in claim 22, wherein:
the curing catalyst accelerating curing of (B) the multifunctional cynate ester is at least one of zinc (II) acetylacetonato, zinc naphthenate, cobalt (II) acetylacetonato, cobalt (III) acetylacetonato, cobalt naphthenate, copper (II) acetylacetonato, and copper naphthenate.

33. A thermosetting resin composition as set forth in claim 22, further comprising;
a curing accelerator for accelerating a reaction between (C) the epoxy resin and the curing agent for accelerating curing of (C) the epoxy resin.

34. The thermosetting resin composition as set forth in claim 22, wherein;
at least one of the following conditions (1) and (2) are satisfied:
(1) a dielectric constant is not higher than 3.0, and a dielectric dissipation factor is not higher than 0.01, after curing with heat at 200° C. to 250° C. for 1 hour to 5 hours; and
(2) adhesion to copper foil is not less than 5N/cm before and after PCT processing.

35. The thermosetting resin composition as set forth in claim 34, wherein:
the condition (1) is satisfied.

36. The thermosetting resin composition as set forth in claim 22, further comprising:
(A) a polyimide resin;
(B) a multifunctional cynate ester; and
(C) an epoxy resin, which are thermosetting components,
(B) the multifunctional cynate ester being at least one of multifunctional cynate esters and/or oligomers thereof,
the multifunctional cynate esters being selected from compounds represented by the following general formula (6): 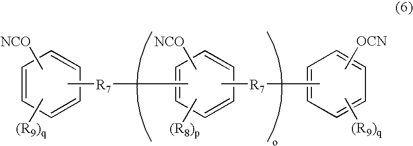
where R₇ is selected from —CH₂—, —C(CH₃)₂—, —C(CF₃)₂—, —CH(CH₃)—, —CH(CF₃), —SO₂—, —S—, —O—, and a bivalent organic group having at least one of a single bond, an aromatic ring, and an aliphatic ring; R₈ and R₉ are identically or differently selected from —H, —CH₃, and —CF₃; o is an integer not less than 0 and not more than 7; and p and q are identical or different integers not more than 0 and not less than 3,
(C) the epoxy resin being at least one of epoxy resins or an alkoxy-group-including silane denatured epoxy resin,
the epoxy resins being represented by the following general formulas (8), (9) and (10): 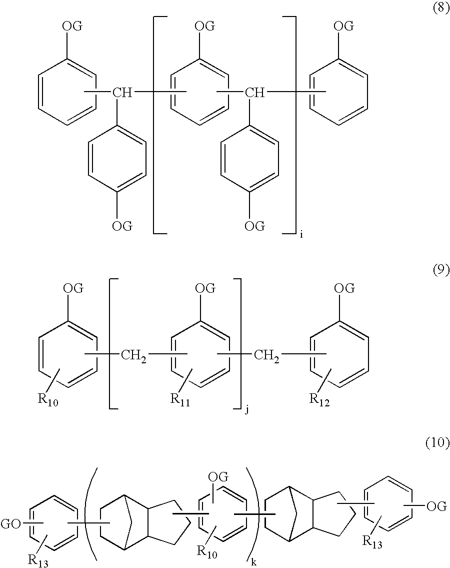
where G is an organic group represented by the following structural formula: 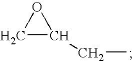
i, J, and k are integers respectively not less than 0 and not more than 5; and R₁₀, R₁₁, R₁₂, and R₁₃ are independently a hydrogen atom or an alkyl group whose carbon number is 1 to 4.

37. A laminate, comprising:
at least one layer including a thermosetting resin composition including:
(A) a polyimide resin;
(B) a multifunctional cynate ester; and
(C) an epoxy resin, which are thermosetting components,
(A) the polyimide resin being soluble polyimide obtained by reacting, with diamines, at least one of acid dianhydride represented by the following general formula (I): 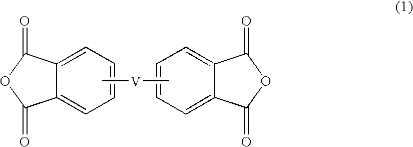
where V is a divalent group selected from the group consisting of —O—, —CO—, —O-T-O—, and COO-T-OCO—; and T is a divalent organic group.

38. A circuit substrate, comprising:
a thermosetting resin composition including:
(A) a polyimide resin;
(B) a multifunctional cynate ester; and
(C) an epoxy resins, which are thermosetting components,
(A) the polyimide resin being soluble polyimide obtained by reacting, with diamines, at least one of acid dianhydride represented by the following general formula (1): 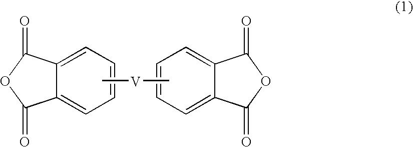
where V is a divalent group selected from the group consisting of —O—, —CO—, —O-T-O—, and COO-T-OCO—; and T is a divalent organic group.
